(19) United States
(12) Patent Application Publication
(10) Pub. No.: US 2019/0309569 A1
(43) Pub. Date: Oct. 10, 2019

(54) ENERGY EFFICIENT FENESTRATION ASSEMBLIES

(71) Applicant: SPRING-E-FRAME, LLC, Thorntown, IN (US)

(72) Inventors: Normand Marchand, Thorntown, IN (US); John Rhoades, Simpsonville, SC (US); Steve Shepard, Fishers, IN (US); Seth Adams, Lafayette, IN (US)

(21) Appl. No.: 16/461,344

(22) PCT Filed: Nov. 16, 2017
(86) PCT No.: PCT/US17/62029

§ 371 Date: May 15, 2019

Related U.S. Application Data
(60) Provisional application No. 62/422,944, filed on Nov. 16, 2016.
(60) Provisional application No. 62/422,993, filed on Nov. 16, 2016.
(60) Provisional application No. 62/440,263, filed on Dec. 29, 2016.

(51) Int. Cl. E06B 7/23

(52) U.S. Cl. CPC E06B 7/2301; E06B 3/285

(57) ABSTRACT

A fenestration assembly is provided. The assembly includes a stationary member, a moveable member coupled to the stationary member, a primary biasing member disposed between the stationary member and the moveable member to provide tension to a film coupled to the moveable member, and a reinforcement member coupled to the stationary member and configured to reinforce the assembly upon tension being provided to the film.

### RELATED APPLICATIONS

This international present application is related to, claims the priority benefit of U.S. Patent Application No. 62/422,944, filed Nov. 16, 2016, U.S. Patent Application No. 62/422,993, filed Nov. 16, 2016, and U.S. Patent Application No. 62/440,263, filed Dec. 29, 2016. The entire disclosure of each of these patent applications is incorporated herein by reference.

### BACKGROUND

Fenestration generally refers to products that fill openings in a building envelope, such as windows, doors, skylights, curtain walls, etc. These products are designed to permit the passage of air, light, vehicles, or people. A building envelope, in turn, generally refers to the separation between the interior and the exterior environments of a building. As such, the building envelope serves as an outer shell that both protects and facilitates climate control of the indoor environment.

During daylight hours, light may be blocked at a window to reduce or eliminate the glare caused by the sun light passing through a window. This blocks a substantial portion of the view from the window, and thereby removes many benefits provided by a window. There have been efforts to modify a window by directly applying thereon a glare-reducing film that is sufficiently transparent so as not to obscure the view through the window.

Unfortunately, directly applying a film to the interior surface of a window, as conventional designs propose, suffers from drawbacks. Specifically, the amount of light and heat that is reflected does not rise to the desired levels to be considered energy efficient. In fact, the conventional window/film combinations absorb a greater amount of light and/or heat than desired through impingement upon the combination and heat remaining contained inside the building envelope.

Further, windows and other fenestration products may include only a single pane of glass and/or may not otherwise perform at an acceptable thermal or radiant energy efficiency. A conventional approach to improving the performance of low-efficiency fenestration products includes simply replacing the window or other fenestration product with a more energy efficient product. However, such a measure may be expensive, inconvenient, or not possible, especially in the case of historical homes, high-rise buildings, apartments or other rental properties, or buildings having a large number of windows.

Therefore, there exists a need for a fenestration assembly that is cost-effective, is easily installable into various types of buildings, and provides a high level of energy efficiency.

### SUMMARY

In accordance with an aspect of the present disclosure, a fenestration assembly is provided. The fenestration assembly including a base configured to be coupled to a window portion, a slide coupled to the base and having a film attachment point, the slide being biased to increase tension of a film attached at the film attachment point, and a reinforcement member coupled to the base and configured to reinforce the assembly upon tensioning of the film.

The assembly may further include a biasing member disposed between the base and the slide and configured to bias the slide to increase tension of the film attached at the film attachment point. The biasing member may be substantially aligned with the film along a direction of tension of the film. The biasing member may be a linear wave spring. The base may include a channel extending in a direction substantially parallel to the film and the slide may include a tab extending in the direction substantially parallel to the film and being disposed in the channel. The assembly may further include a cap coupled to the slide and configured to cover at least a portion of the slide. The cap may include at least one protrusion extending in a direction substantially perpendicular to the film, the at least one protrusion may be configured to further increase tension of the film. The window portion may be a window frame. The window portion may be a window pane. The base may be configured to be coupled to the window portion with a bracket coupled to the base, and the bracket may provide tension to the base in a direction that is substantially parallel to a direction of tension on the film.

In accordance with an aspect of the present disclosure, a fenestration assembly is provided. The assembly includes a stationary member, a moveable member coupled to the stationary member, a primary biasing member disposed between the stationary member and the moveable member to provide tension to a film coupled to the moveable member, and a reinforcement member coupled to the stationary member and configured to reinforce the assembly upon tension being provided to the film.

The primary biasing member may be substantially aligned with a direction of tension of the film. The assembly may further include a secondary biasing member disposed at the moveable member to further provide tension to the film. The moveable member may include an inner moveable member and an outer moveable member. The secondary biasing member may be formed between the inner moveable member and the outer moveable member. The secondary biasing member may be formed by at least one of the inner moveable member and the outer moveable member having at least one protrusion extending substantially perpendicular to a direction of tension on the film. The primary biasing member may be a linear wave spring. The stationary member may include a channel extending substantially parallel to a direction of tension on the film, and the moveable member may include a tab extending substantially parallel to the direction of tension on the film and being disposed within the channel. The assembly may further include a bracket coupled to the stationary member, and the bracket may be configured to be coupled to a window portion and may be providing tension to the base in a direction that is substantially parallel to a direction of tension on the film.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein;

FIG. 1A is a top plan view of a fenestration assembly according to an embodiment of the present disclosure;

FIG. 1B is an enlarged top plan view of a fenestration assembly according to an embodiment of the present disclosure;

FIG. 2 is an enlarged cross sectional view of a fenestration assembly according to an embodiment of the present disclosure;

FIG. 3 is an enlarged cross sectional view of a fenestration assembly according to an embodiment of the present disclosure;

FIG. 4 is an enlarged cross sectional view of a fenestration assembly according to an embodiment of the present disclosure;

FIG. 5 is an enlarged cross sectional view of, a fenestration assembly according to an embodiment of the present disclosure;

FIG. 6 is an enlarged cross sectional view of a fenestration assembly according to an embodiment of the present disclosure;

FIG. 7 is an enlarged cross sectional view of a fenestration assembly according to an embodiment of the present disclosure;

FIG. 8 is a top plan view of a fenestration assembly fixture according to an embodiment of the present disclosure;

FIG. 9 is a cross sectional view of a system for assembling a fenestration assembly according to an embodiment of the present disclosure;

FIG. 10 is a cross sectional view of a system for assembling a fenestration assembly according to an embodiment of the present disclosure;

FIG. 11 is a cross sectional view of a system for assembling a fenestration assembly according to an embodiment of the present disclosure;

FIG. 12 is an enlarged top plan view of a fenestration assembly fixture according to an embodiment of the present disclosure;

FIG. 13 is a cross sectional view of a system for assembling a fenestration assembly according to an embodiment of the present disclosure;

FIG. 14 is a cross sectional view of a system for assembling a fenestration assembly according to an embodiment of the present disclosure;

FIG. 15 illustrates a method of assembling a fenestration assembly according to an embodiment of the present disclosure;

FIG. 16 is an enlarged cross sectional view of a fenestration assembly according to an embodiment of the present disclosure;

FIG. 17 is an enlarged cross sectional view of a fenestration assembly according to an embodiment of the present disclosure;

FIG. 18 is an enlarged cross sectional view of a fenestration assembly according to an embodiment of the present disclosure;

FIG. 19 is an enlarged cross sectional view of a fenestration assembly according to an embodiment of the present disclosure;

FIG. 20 is an enlarged cross sectional view of a fenestration assembly according to an embodiment of the present disclosure;

FIG. 21 is an enlarged cross sectional view of a fenestration assembly according to an embodiment of the present disclosure;

FIG. 22 is an enlarged cross sectional view of a fenestration assembly according to an embodiment of the present disclosure;

FIG. 23 is an enlarged cross sectional view of a fenestration assembly according to an embodiment of the present disclosure;

FIG. 24 illustrates forces of a biasing member of a fenestration assembly according to an embodiment of the present disclosure;

FIG. 25 is an enlarged cross sectional view of a fenestration assembly according to an embodiment of the present disclosure;

FIG. 26 is an enlarged cross sectional view of a fenestration assembly according to an embodiment of the present disclosure;

FIG. 27 is an enlarged cross sectional view of a fenestration assembly according to an embodiment of the present disclosure;

FIG. 28 is an enlarged cross sectional view of a fenestration assembly according to an embodiment of the present disclosure;

FIG. 29 is an enlarged cross sectional view of a fenestration assembly according to an embodiment of the present disclosure;

FIG. 30 is an enlarged cross sectional view of a fenestration assembly according to an embodiment of the present disclosure;

FIG. 31 is an enlarged cross sectional view of a fenestration assembly according to an embodiment of the present disclosure;

FIG. 32 is a cross sectional view of a system for assembling a fenestration assembly according to an embodiment of the present disclosure;

FIG. 33 is an enlarged cross sectional view of a fenestration assembly according to an embodiment of the present disclosure; and

FIG. 34 is an enlarged cross sectional view of a fenestration assembly according to an embodiment of the present disclosure.

FIG. 35 illustrates a method of replacing film in a fenestration assembly according to an embodiment of the present disclosure;

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

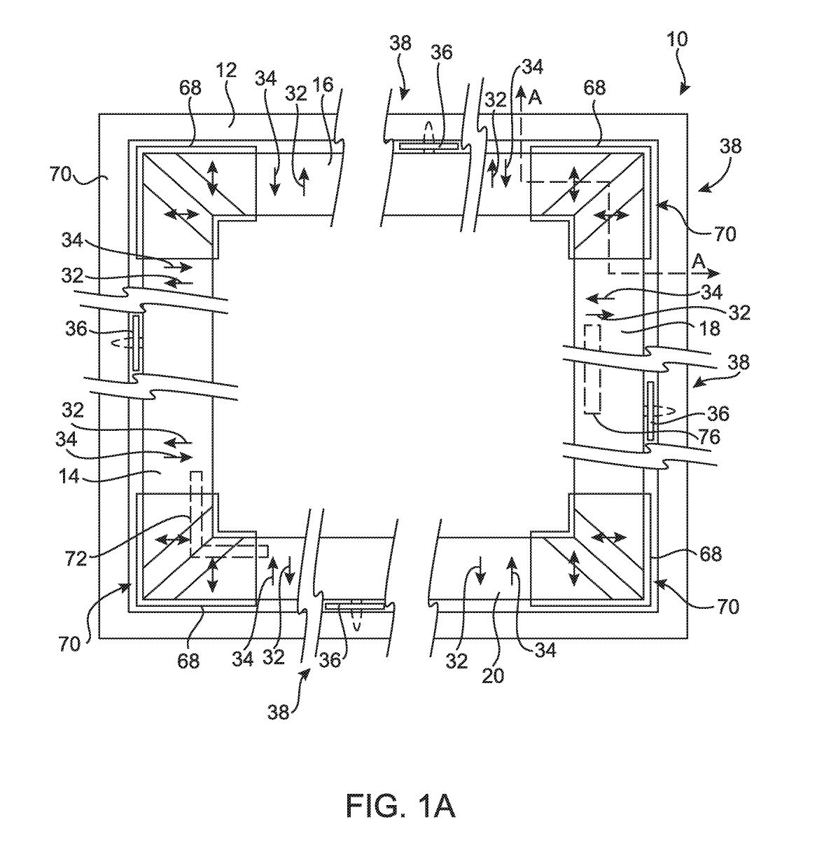

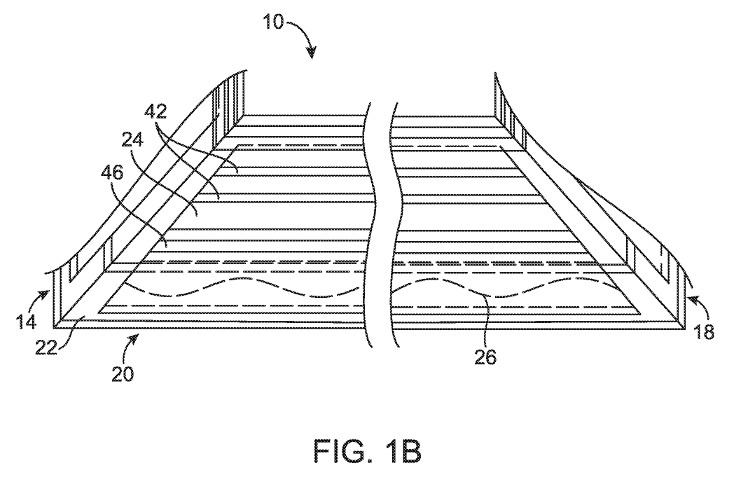

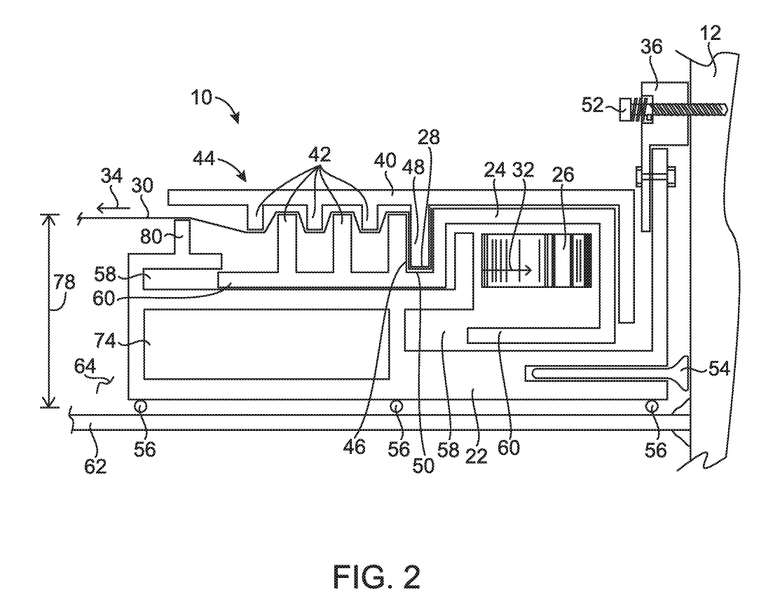

Referring now to the drawings, FIG. 1 A illustrates a fenestration assembly 10 for installation into a building opening 12, such as a window or door opening in two non-limiting examples. In an embodiment, the fenestration assembly 10 is installed against or adjacent to a window pane 62, as illustrated in FIG. 2. The fenestration assembly 10 of an embodiment includes a first side 14, a second side 16, a third side 18, and a fourth side 20.

In one or more embodiments, the assembly 10 includes one or more brackets 36, as illustrated in FIG. 1A. In additional embodiments, the assembly 10 does not include the brackets 36. As discussed in further detail below, the bracket 36 couples, fixes, or attaches the assembly 10 to the building opening 12, such as a window frame in one non-limiting example. The bracket 36 of an embodiment may be positioned at a central location 38 of one or more of the sides 14, 16, 18, 20 to provide tension separate from, in addition to, or as a supplement to a primary biasing force 32 and against a film tensile force 34, explained in further detail below, and/or straighten the one or more sides 14, 16, 18, 20 upon installation of the assembly 10 into the opening 12.

Referring now to the embodiment of FIGS. 1B and 2 with continuing reference to FIG. 1A, each of the sides 14, 16, 18, 20 includes a base 22, a slide 24, and a primary biasing member 26. FIG. 1B shows an enlarged plan view of the base 22, the slide 24, and the primary biasing member 26 positioned under the slide 24 of the side 20 of the assembly 10. The components shown in FIG. 1B may be included in each of the slides 14, 16, 18, 20. Some components of the assembly 10, such as a cap 40 and a film 30, described in further detail below, are not shown in FIG. 1B for clarity purposes. In an embodiment, the base 22 is configured to be coupled to the building opening 12, such as a window portion in a non-limiting example. The window portion described herein refers to a window frame, a window pane, a window sill, and/or any other portion of a window. As illustrated in FIG. 1A, a corner key 72 joins two of the sides 14, 16, 18, 20. The corner key 72 is positioned in a keyway 74, as illustrated in FIG. 2. The corner key 72 is positioned at all corners of the assembly 10 in an embodiment to reinforce and/or add rigidity to the assembly 10. Further illustrated in FIG. 1A, an optional straight key 76 may be positioned in the keyway 74 of one or more of the sides 14, 16, 18, 20 in order to reinforce and/or add rigidity to the assembly 10 and/or resist or compensate for inward bowing or cambering of one or more of the sides 14, 16, 18, 20.

The slide 24 is positioned adjacent to the base 22, as illustrated in FIG. 2. The primary biasing member 26 is positioned between the slide 24 and the base 22 to apply the primary biasing force 32 against each of the slide 24 and the base 22. In an embodiment, the assembly 10 includes a film 30 configured to extend between the sides 14, 16, 18, 20 of the fenestration assembly 10. The film 30 in one or more embodiments of the present disclosure includes a security and/or window film between 1 mil and 30 mil in an embodiment, between 1.5 mil and 18 mil in another embodiment, and between 2 mil and 12 mil in another embodiment. The film 30 has a thickness below 1 mil in an embodiment and a thickness above 30 mil in an embodiment. One non-limiting example of a commercially available product includes Silver 35 window film available from 3M Corporation of Minneapolis, Minn.

The base 22 includes one or more slide channels 58 extending a direction substantially parallel to the film 30 in the embodiment illustrated in FIG. 2. The slide 24 includes one or more tabs 60 extending in a direction substantially parallel to the film 30 such that the one or more tabs 60 is positioned at least partially inside the one or more slide channels 58. The one or more slide channels 58 and the one or more tabs 60 allow the slide 24 to move and/or adjust relative to the base 22 in a direction substantially parallel with the film 30 while being coupled to the base 22, mated with the base 22, or otherwise fixed from movement in a direction not parallel to the film 30.

The primary biasing member 26 includes a linear wave spring in one or more embodiments illustrated herein. In additional embodiments, the primary biasing member 26 includes one or more circular or round wave springs, one or more round or linear sinuous spring, one or more springs of other types, and/or configurations known by those having ordinary skill in the art after reviewing and understanding the present disclosure. Further, after reviewing and understanding the present disclosure, one having ordinary skill in the art will recognize many different biasing structures and methods, such as pneumatic, hydraulic, electrical, and/or magnetic biasing means to name non-limiting examples, and such biasing structures and methods form one or more particular embodiments of the primary biasing member 26 of the present disclosure. Biasing member 26 may be tailored to the particular fenestration assembly embodiment so as to produce desired tautness characteristics in film 30, desired rigidity characteristics in sides 14, 16, 18, 20, and/or desired geometric characteristics in sides 14, 16, 18, 20.

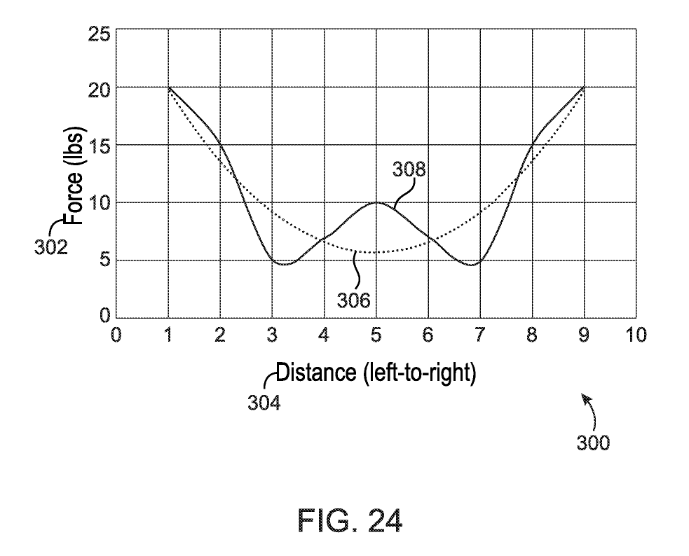

Referring now to FIG. 24, a chart 300 illustrates a force 302 of the primary biasing member 26 relative to a longitudinal point 304 along the primary biasing member 26. The primary biasing member 26 of the embodiment of FIG. 24 is a quantized linear wave spring. Such quantized linear wave springs allow customizable forces to be applied to the assembly 10 to suit the application. As illustrated in FIG. 24, the force 302 is relatively low at a central longitudinal point 304 and relatively high at the outer longitudinal points 304. A force line 308 illustrates the varying force 302 dependent upon the longitudinal point 304. A polynomial trend line 306 illustrates how the force 304 evolves over the length of the primary biasing member 26. Once the primary biasing member 26 is incorporated into the assembly 10, the values of the polynomial trend line 306 will be the measurable values associated with the tension applied to the slide 24 and/or the film 30. Any one or more embodiments of the assembly 10 of the present disclosure may incorporate a custom primary biasing member 26 as described herein to increase tension force at a certain area relative to another area. For example, the primary biasing member 26 described above having the force 302 relatively low at a central longitudinal point 304 and relatively high at the outer longitudinal points 304 may be utilized to maximize tension at areas adjacent the junctions 70 while minimizing the tension at the central locations 38 to prevent twisting, curving, or any other unacceptable deformation of the assembly 10 at the central locations 38.

The assembly 10 further includes a cap 40 coupled to the slide 24 and covering, attaching to, or otherwise being positioned adjacent to at least a portion of the slide 24, as illustrated in the embodiment of FIG. 2. In the embodiment of FIG. 2, the cap 40 moves with the slide 24, is moveable relative to the base 22, and/or is otherwise adjustable within the assembly 10. The cap 40 forms an outer moveable member while the slide 24 forms an inner moveable member in an embodiment. The film 30 is positioned between the slide 24 and the cap 40 to apply tension to the film 30 and/or secure the film 30 to the moveable slide 24/cap 40 subassembly or member 44 illustrated in the embodiment of FIG. 2. Moveable member 44 includes all features of the slide 24 and the cap 40 in an embodiment. In one or more embodiments, the cap 40 further acts as a cover to improve the aesthetic appearance of the assembly and/or protect the slide, base, and primary biasing member 26 from damage and/or dirt or other foreign objects. As shown in FIG. 1A, the base 22 of an embodiment is a single, stationary member while each side 14, 16, 18, 20 includes the moveable members 44.

The slide 24 includes a film attachment point 28 such that, when the primary biasing force 32 acts on the slide 24, the slide 24 is driven, urged, or biased to increase tension of the film 30 attached at the film attachment point 28. The slide 24 includes a film attachment channel 46 configured to receive a film attachment protrusion 48 of the cap 40 in the embodiment illustrated in FIG. 2. In one or more embodiments, the film attachment point 28 and/or the film attachment channel 46 includes an adhesive 50, such as a sprayable glue in one non-limiting example, to hold, secure, or otherwise attach the film 30, at least initially, to the slide 24.

As illustrated in FIG. 1A, the primary biasing force 32 acts against a film tensile force 34 at each of the sides 14, 16, 18, 20 to position the film 30 in the assembly 10 while minimizing wrinkles or other visibility defects or issues. As illustrated in the embodiment of FIG. 2, the base 22 is coupled to the opening 12, such as a window portion in one non-limiting example, with the bracket 36 coupled to the base 22 at an inside space 64 of the window pane 62. In an embodiment, the bracket 36 provides tension to the base 22 in a direction that is opposite and substantially parallel to the film tensile force 34 or a direction of tension on the film 30. The bracket 36 of one or more embodiments includes an adjustable and/or resilient fastener 52 to allow compensation for, or adjustment in response to, an increase or decrease of the film tensile force 34 or any other force that may affect the spacing of the one or more sides 14, 16, 18, 20 at the central location 38 or any other location from the opening 12. In one or more embodiments, the bracket 36 and/or the fastener 52 is integral with or separately coupled to the base 22. In an embodiment, the primary biasing force 32 is greater than or substantially equal to the film tensile force 34 such that the primary biasing force 32 is sufficient to counteract the film tensile force 34 without the presence of or application of any force provided by the bracket 36. In additional embodiments, a force provided by the bracket 36 or another component supplements the primary biasing force 32.

The base 22 of particular embodiments illustrated in the present disclosure may further include one or more end sealing members 54 on an outer side of the base 22 and/or one or more face sealing members 56 disposed between the base 22 and the window pane 62 or other surface. The end sealing member 54 and the face sealing member 56 may be made from a resilient, compliant, and/or otherwise soft material, such as a foam elastomeric or polymeric material in a non-limiting example. As illustrated in one or more embodiments of the present disclosure, the end sealing member(s) 54 are positioned in a slot that may also house the bracket(s) 36. Similarly, the bracket(s) 36 may be positioned in a slot with or without the end sealing member(s) 54.

In an embodiment, the base 22, the bracket(s) 36, and/or another component of the assembly 10 is attached to the window pane 62 with one or more adhesives. In such an embodiment, the base 22, the bracket(s) 36, and/or the assembly 10 is rigidly or securely coupled to the window pane 62 such that the thermal expansion of the base 22, the bracket(s) 36, and/or the assembly 10 generally corresponds with the thermal expansion of the window pane 62. Such an arrangement allows consistent and reliable mounting, sealing, and/or spacing between the window pane 62, the opening 12, and/or the assembly 10. The adhesive includes Loctite® to name a non-limiting example.

The cap 40 and/or the slide 24 of the embodiment shown in FIG. 2 includes one or more nubs or protrusions 42 extending in a direction substantially perpendicular to the film 30 to further increase tension of the film 30. The one or more nubs or protrusions 42 are each considered a secondary biasing member as each supplements the primary biasing member 26 to apply tension to the film 30. Although three protrusions 42 are shown on the cap 40 and two protrusions 42 are shown on the slide 24 in the embodiment of FIG. 2, after reviewing and understanding the present disclosure, one having ordinary skill in the art will recognize that any number of protrusions 42 and any combination or type of protrusions 42 between the cap 40 and slide 24 may be utilized in order to increase tension on the film 30. In an embodiment, the cap 40 and/or the slide 24 includes no protrusions 42.

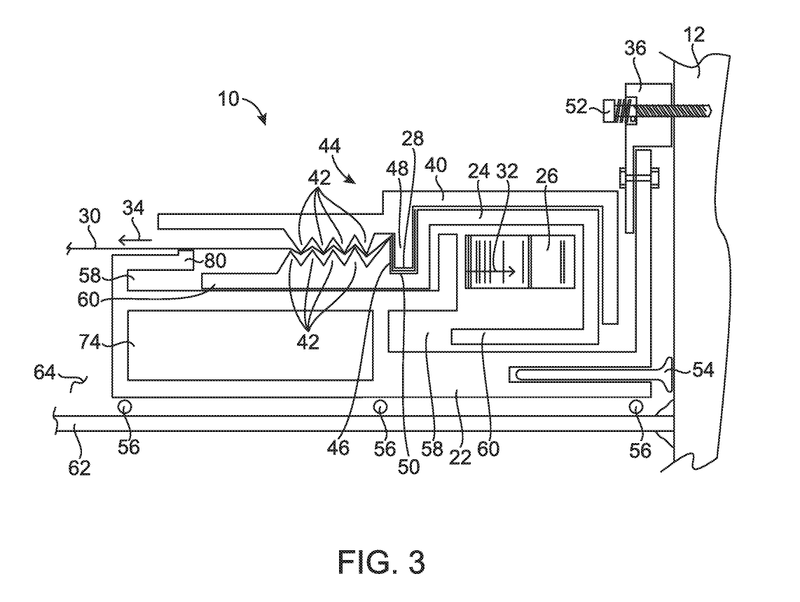

Referring now to FIG. 3, in the embodiment illustrated, one or more nubs or protrusions 42 are not substantially perpendicular to the film 30. FIG. 3 illustrates an embodiment of the assembly 10 that features a lower profile or thickness. It will be appreciated that the dimensions of any component of the assembly 10 may be optimized or otherwise varied to suit a particular function, fitment, and/or requirement, such as by varying one or more dimensions or physical properties of the one or more protrusions 42, slide 24, base 22, and/or primary biasing member 26 in non-limiting examples. As further illustrated in FIG. 3, the film tensile force 34 provided by the film 30 operates on the same plane as the primary biasing force 32 provided by the primary biasing member 26. In an embodiment, the center of the primary biasing force 32 is located on the same plane as the film tensile force 34 provided by the film 30. In an embodiment, the portion of the film 30 surrounded by the sides 14, 16, 18, 20 is spaced from the window pane 62 upon installation in an embodiment the same distance as the primary biasing member 26 is spaced from the window pane 62 upon installation in the same embodiment. Alignment of the primary biasing member 26 and the film 30 prevents or reduces twisting, torqueing, or creation of one or more moments of one or more of the sides 14, 16, 18, 20 of the assembly 10 or between two or more components, such as between the base 22 and the slide 24, of the assembly 10.

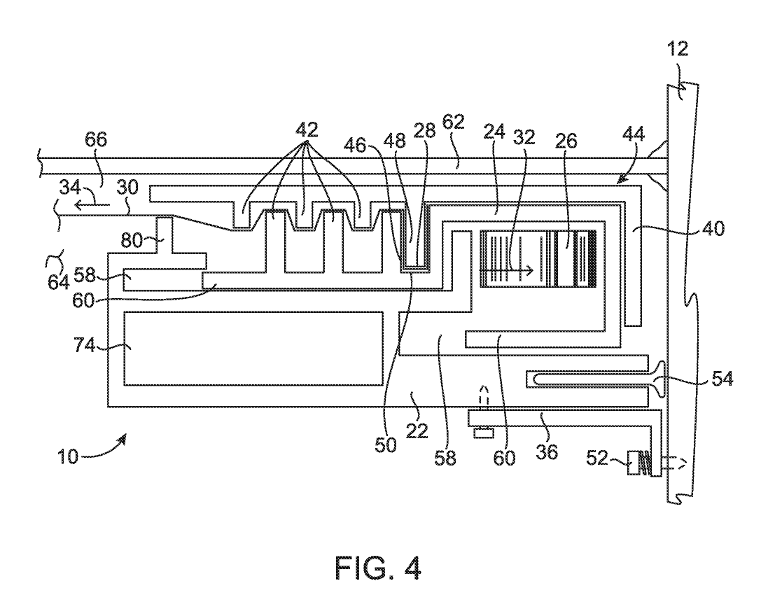

FIGS. 2 and 3 illustrate embodiments of an assembly 10 having the base 22 configured to be positioned adjacent to the window pane 62, i.e., the base 22 is positioned closer to the window pane 62 than the slide 24 or cap 40. An inside space distance 78 is determined by a base film edge 80, as illustrated in the embodiment of FIG. 2. The base film edge 80 of the sides 14, 16, 18, 20 of an embodiment provides a common surface around the assembly 10 to minimize visible imperfections in the film 30. Any embodiment illustrated or described herein may include the base film edge 80. Referring now to FIG. 4, the assembly 10 of an embodiment includes the slide 24 and/or the cap 40 configured to be positioned adjacent the window pane 62 in the inside space 64, i.e., the slide 24 and/or the cap 40 is positioned closer to the window pane 62 than the base 22. It will be appreciated that the embodiment illustrated in FIG. 4 offers an assembly 10 configured to form an air gap 66 between the window pane 62 and the film 3.0 that may be smaller than the air gap 66 formed between the window pane 62 and the film 30 of the embodiments illustrated in FIGS. 2 and 3.

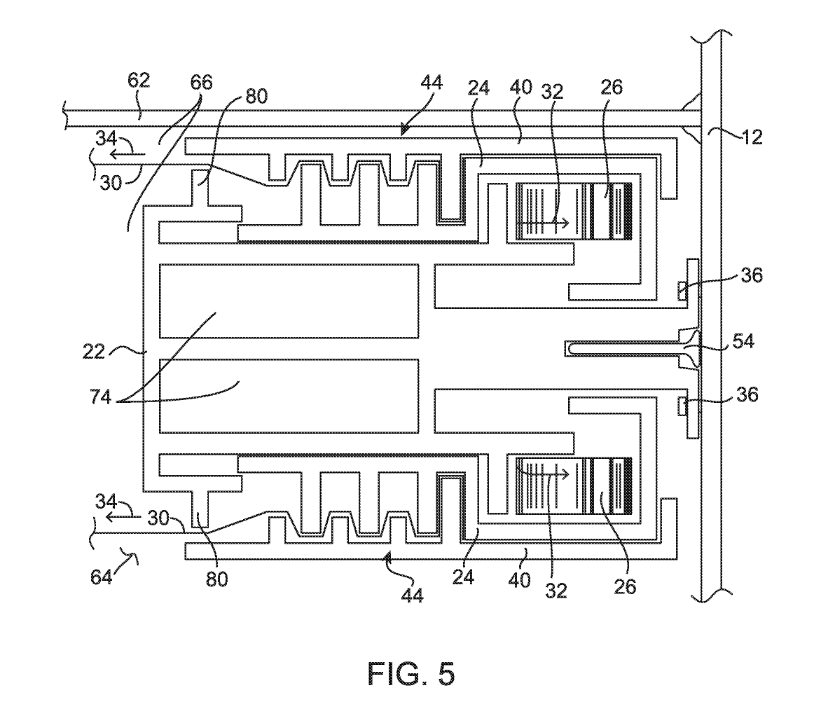

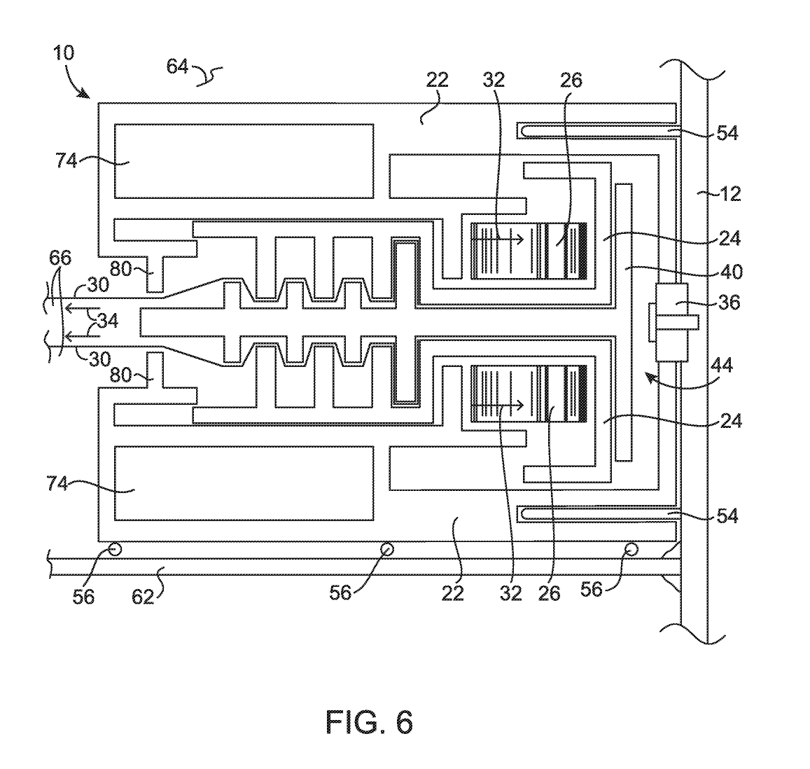

Reference is now made to FIGS. 5 and 6, which illustrate embodiments of the assembly 10 forming multiple air gaps 66 between the window pane 62 and the film 30 and between multiple layers of the film 30. The embodiment of FIG. 5 illustrates the assembly 10 having the base 22 at an internal location of the assembly 10. The slides 24 and/or the caps 40 are disposed outside of the base 22 as illustrated in FIG. 5. The embodiment of FIG. 6 illustrates the assembly 10 having the base 22 at an external location of the assembly 10. One or more slides 24 and/or caps 40 are positioned internally as illustrated in FIG. 6. After reviewing and understanding the present disclosure, one of ordinary skill in the art will recognize that additional layers of the film 30 forming additional air gaps 66 may be incorporated into any of the embodiments disclosed herein to form additional embodiments, and such additional embodiments form part of the present disclosure.

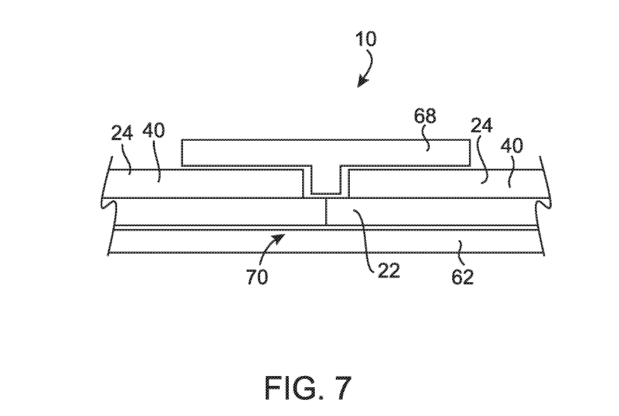

FIG. 7 is a cross-sectional view along lines A-A in FIG. 1A. With reference to FIG. 7 and continuing reference to. FIG. 1, one or more embodiments of the present disclosure include a corner cap 68 at a junction 70 of each of the sides 14, 16, 18, 20. The corner cap 68 is configured to be fixed relative to the base 22 and cover the junction 70. In an embodiment, the corner cap 68 is fixed directly to the base 22, such as with one or more adhesives, fasteners, interference fit, fusing, and/or welding in non-limiting examples. Because the slide 24 and/or the cap 40 is configured to move or otherwise adjust relative to the base 22, the corner cap 68 covers the ends of the moveable slide 24 and/or cap 40 members to protect the components, improve insulation at the ends of the slide 24 and/or the cap 40, and improve the aesthetic appearance of the assembly 10.

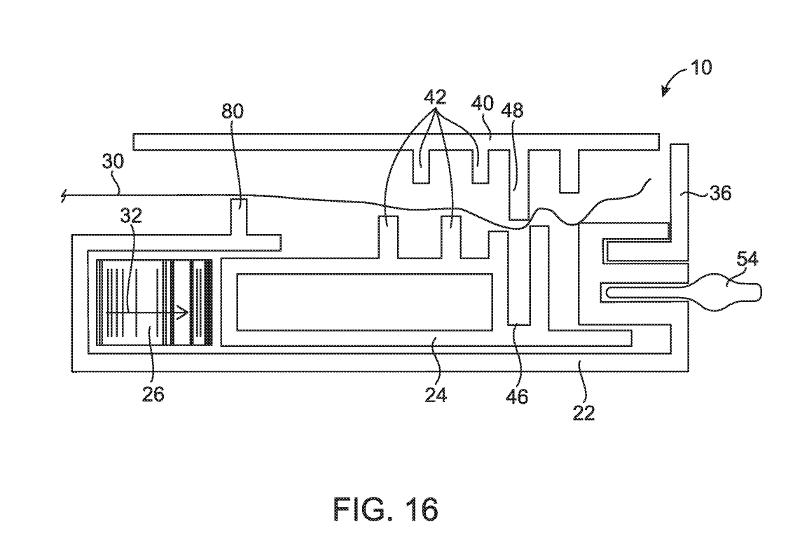

Referring now to FIG. 16, an embodiment of the assembly 10 is illustrated. The assembly 10 of FIG. 16 includes the primary biasing member 26 disposed at an inside location of the slide 24 between the base 22 and the slide 24. The cap 40 of the assembly 10 of FIG. 16 pushes, inserts, or otherwise moves the film 30 into the film attachment channel 46 to attach the film 30 to the slide 24. As explained in further detail below, upon attachment of the film 30 to the slide 24, the slide 24 and the cap 40 move inward or toward the film 30 against the primary biasing force 32. One or more protrusions 42 may be provided to further increase tension on the film 30, as explained above.

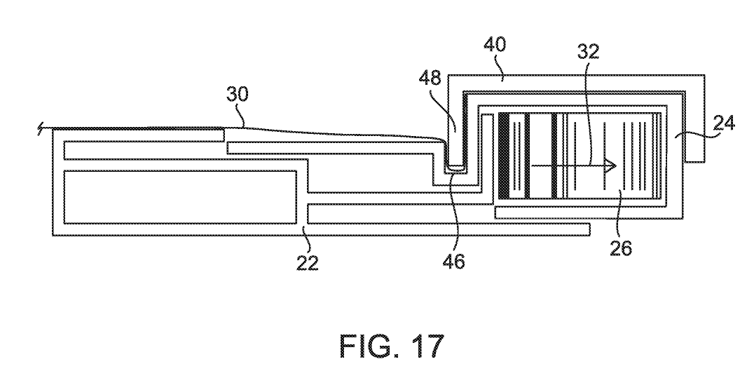

Referring now to FIG. 17, an embodiment of the assembly 10 is provided. The primary biasing member 26 is disposed between the base 22 and the slide 24, as described in embodiments above. The assembly 10 of FIG. 17 includes a cap 40 that includes the film attachment protrusion 48 to attach the film 30 to the slide 24, but does not include one or more protrusions 42 to further increase tension on the film 30. Upon attachment of the film 30 to the slide 24, the film 30 travels into the film attachment channel 46 and increases tension on the film 30 against the primary biasing force 32.

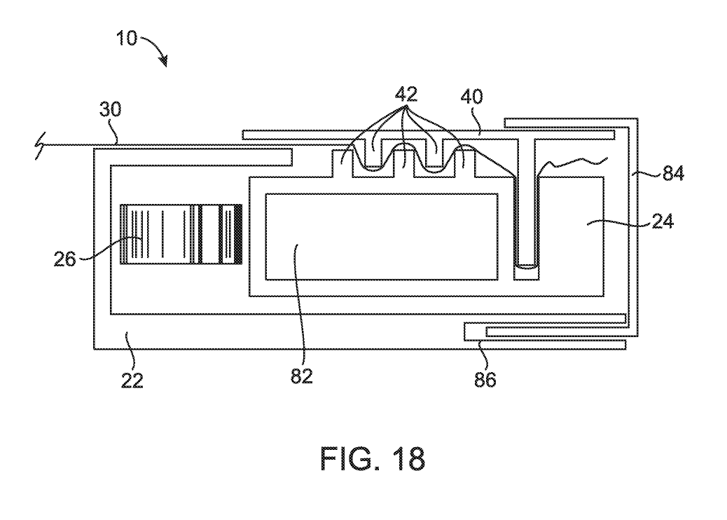

Referring now to FIG. 18, an embodiment of the assembly 10 is provided. The assembly 10 of FIG. 18 includes the primary biasing member 26 disposed between the slide 24 having a generally box, square, or rectangular shaped portion 82 and the base 22. The assembly of FIG. 18 further includes an outer clip 84 configured to fit within an outer slot 86 or outside of the base 22. The outer clip 84 may additionally fit outside of the cap 40 illustrated in FIG. 18 to at least partially enclose the assembly 10 and/or secure the cap 40 to the slide 24. The outer slot 86 may further contain one or more end sealing members 54 and/or one or more brackets 36 not illustrated in FIG. 18.

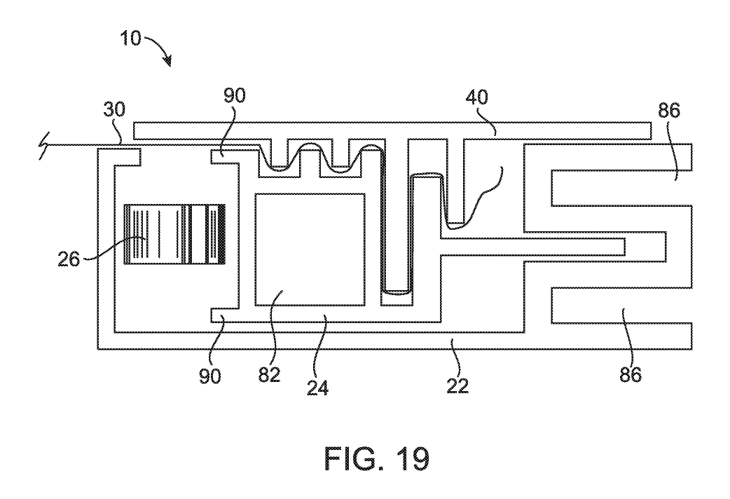

Referring now to FIG. 19, an embodiment of the assembly 10 is provided. The assembly 10 illustrated in FIG. 19 includes the primary biasing member 26 disposed between the base 22 and the slide 24 whereby an upper opening 88 of the base 22 improves the ease of assembly by allowing the slide .24 to be easily positioned within the base 22 as illustrated. The slide 24 includes the generally box, square, or rectangular shaped portion 82. One or more outer slots 86 are provided to secure or contain one or more end sealing members 54, one or more brackets 36, and/or one or more outer clips not shown in FIG. 19. The slide 24 includes one or more slide tabs 90 configured to be disposed against or adjacent to the primary biasing member 26 to secure the primary biasing member 26 between the base 22 and the slide 24.

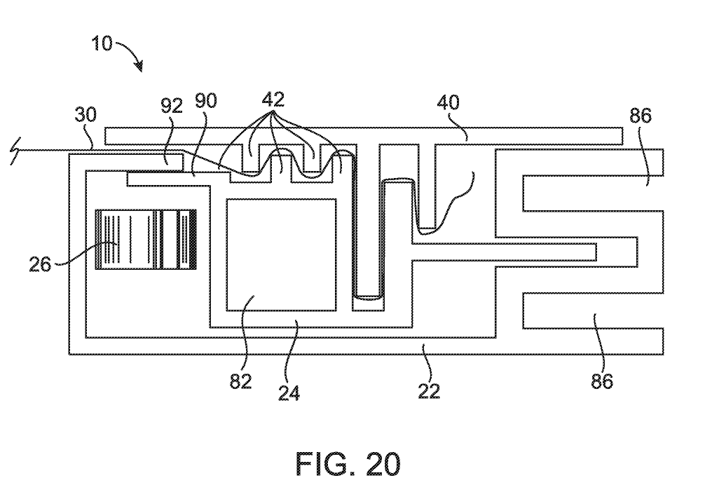

Referring now to FIG. 20, an embodiment of the assembly 10 is provided. The assembly 10 illustrated in FIG. 20 including the primary biasing member 26 being disposed between the base 22 and the slide 24 whereby the upper opening 88 of the base 22 improves the ease of assembly by allowing the slide 24 to be easily positioned within the base 22 as illustrated. The slide 24 of FIG. 20 includes the upper slide tab 90 extending under an upper portion 92 of the base 22 to further secure the primary biasing member 26 .between the base 22 and the slide 24.

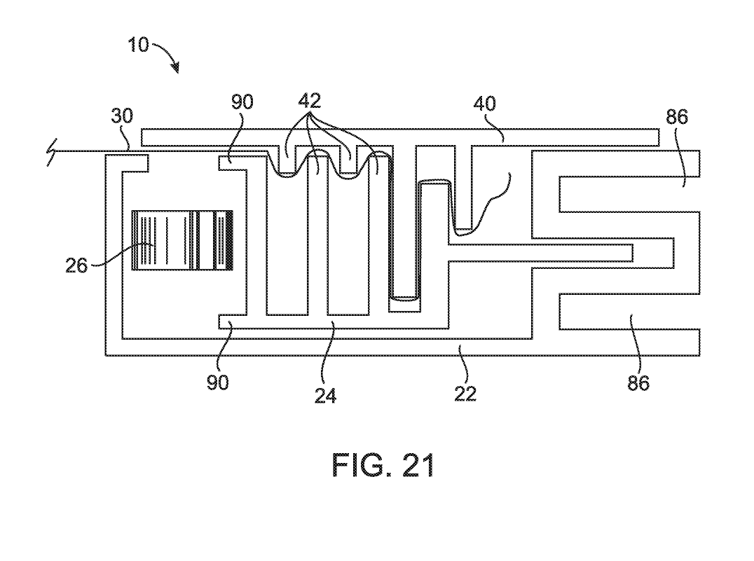

Referring now to FIG. 21, an embodiment of the assembly 10 is provided. The assembly 10 illustrated in FIG. 21 including the primary biasing member 26 being disposed between the base 22 and the slide 24 whereby the upper opening 88 of the base 22 improves the ease of assembly by allowing the slide 24 to be easily positioned within the base 22 as illustrated. The slide 24 does not include the generally box, square, or rectangular shaped portion 82 illustrated in FIGS. 18-20. The protrusions 42 of the slide 24 are provided as biasing members and, in particular embodiments, serve as structural reinforcement members for the slide 24. Although the protrusions 42 of the cap 40 extend only to an upper area of the slide 24, the protrusions 42 of the cap 40 and/or the slide 24 may extend further below in one or more embodiments.

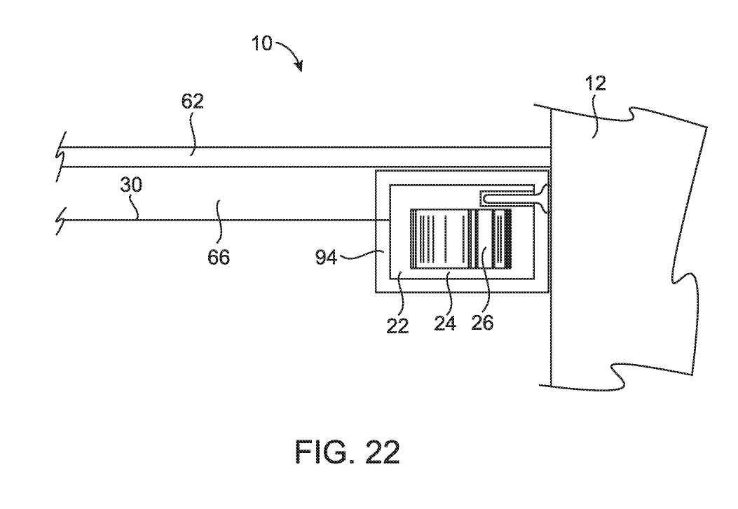

Referring now to FIG. 22, an embodiment of the assembly 10 including an insulation member 94 is provided. The base 22, the slide 24, and the primary biasing member 26 of the embodiment of FIG. 22 include the structure(s) and function(s) of any embodiment disclosed herein, and are depicted conceptually in FIG. 22. The temperature differential on opposite sides of the film 30 may reach extremely high values. Severely cold temperatures may cause immobility and/or locking of the slide 24 and/or the primary biasing member 26, and extreme heat may adversely affect the performance and/or function of the primary biasing member 26 by changing the biasing force. In the embodiment illustrated in FIG. 22, the insulation member 94 is provided in the air gap 66, around the base 22, and/or on or around another portion of the assembly 10.

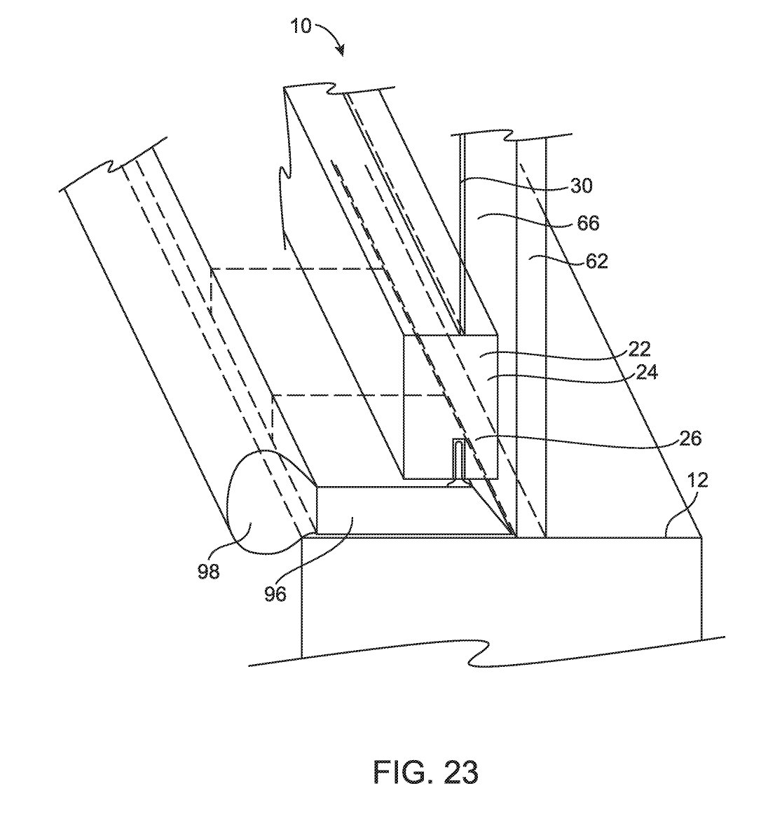

Referring now to FIG. 23, an embodiment of the assembly 10 is provided that includes a conduit 96 configured to collect, transport, and/or contain liquid, such as condensation formed against the window pane 62 and/or the film 30 .or anywhere else within the air gap 66. The conduit 96 of an embodiment is disposed against and/or adjacent to the building opening 12, such as a window sill in one non-limiting example. The base 22, the slide 24, and the primary biasing member 26 of the embodiment of FIG. 23 include the structure(s) and function(s) of any embodiment disclosed herein, and are depicted conceptually in FIG. 23. The conduit 96 is disposed outside of the base 22 in an embodiment, as generally illustrated in FIG. 23. In an embodiment, the assembly 10 includes a collector 98 disposed at an interior end 160 of the conduit 96. In an embodiment, the conduit 96 substantially spans the entire length and/or width of the base 22. In an embodiment, the collector 98 substantially spans the entire length of the conduit 96. In an embodiment, the collector 98 includes cheese cloth and/or another material or structure configured to collect or contain liquid or moisture. In an embodiment, the conduit 96 is angled to promote the transport of a liquid or condensation by gravity to the collector 98 and/or an interior side of the assembly 10.

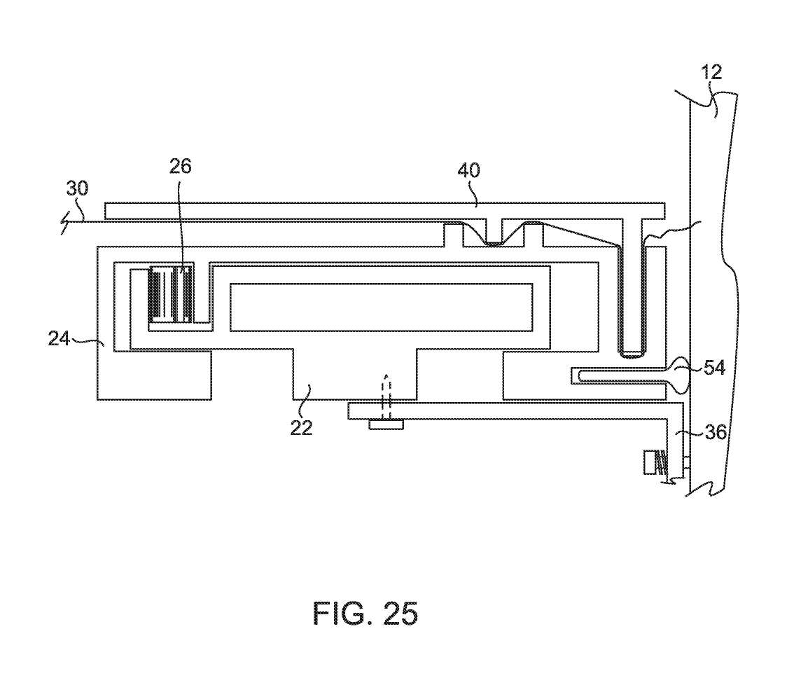

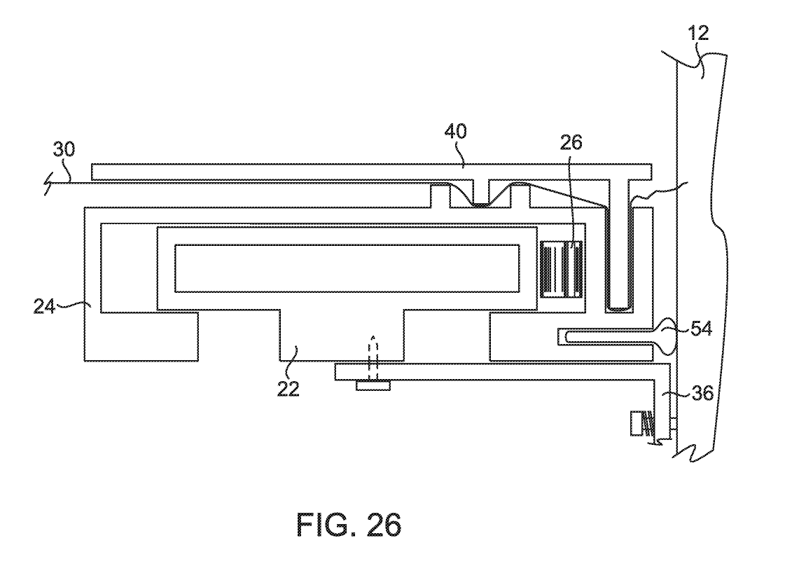

Referring now to FIGS. 25 and 26, at least two embodiments of the assembly 10 are illustrated that include the base 22 being at least partially disposed within the slide 24. Referring to FIG. 25, the primary biasing member 26 is positioned between the stationary base 22 and the moveable slide 24 at an inner location of the slide 24 and the base 22. As with other embodiments of the present disclosure, the bracket 36 is coupled to the base 22 to fix, secure, or otherwise attach the assembly 10 to the building opening 12 with the resilient or otherwise flexible sealing member 54 disposed between the slide 24 and the building opening 12. The film 30 is positioned between the slide 24 and the cap 40.

FIG. 26 illustrates the primary biasing member 26 being positioned between the stationary base 22 and the moveable slide 24 at an outer location of the slide 24 and the base 22 as illustrated in FIG. 26. As with other embodiments of the present disclosure, the bracket 36 is coupled to the base 22 to fix, secure, or otherwise attach the assembly 10 to the building opening 12 with the resilient or otherwise flexible sealing member 54 disposed between the slide 24 and the building opening 12. The film 30 is positioned between the slide 24 and the cap 40.

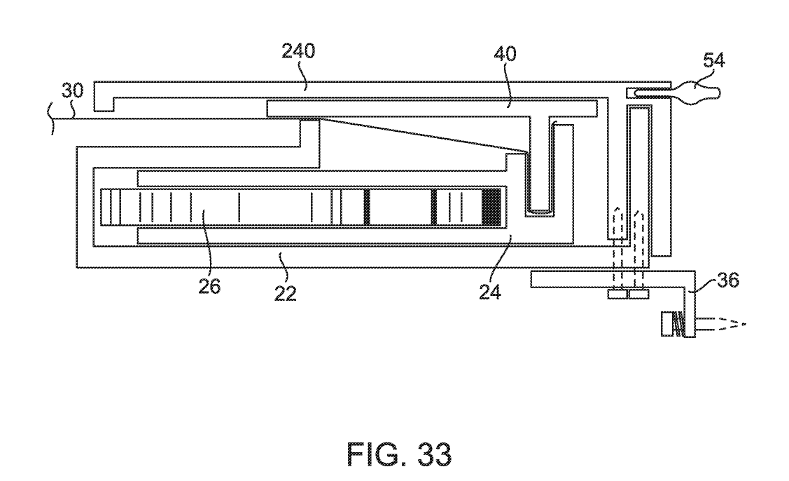

Referring now to FIG. 33, an embodiment of the assembly 10 is illustrated that includes a reinforcement member 240 coupled to the base 22 and configured to reinforce the assembly 10 upon tensioning of the film 30. In an embodiment, the reinforcement member 240 is coupled to the slide 24. Further, the reinforcement member 240 extends in a direction parallel to the film 30 illustrated in FIG. 33 over the cap 40. The reinforcement member 240 provides enhanced tension for the base 22 and/or other components of the assembly 10 along the length of the assembly 10. For example, when tension is applied to the film 30, and the base 22 or another component is compelled to twist or torque to react to the force, the reinforcement member 240 retains the alignment and positioning of the assembly 10 and each of its components. Similarly, when tension is applied to the film 30 and the central location 38 of one or more of the sides 14, 16, 18, 20 is compelled to deform in a direction of the tension, the reinforcement member 240 reduces or eliminates unacceptable curving or deforming of the sides 14, 16, 18, 20.

The reinforcement member 240 extends along each of the sides 14, 16, 18, 20 with separate reinforcement members 240 being coupled to each of the sides 14, 16, 18, 20 in an embodiment. Separate reinforcement members 240 may be miter cut and joined or any other known method at each junction 70. In an additional embodiment, a single reinforcement member 240 integrally formed to have four sides to couple with the sides 14, 16, 18, 20 is provided. The reinforcement members 240 allow the corner cap 68 to be eliminated in one or more embodiments. The reinforcement member 240 offers a clean, homogenous appearance to the assembly 10. Additionally, with the reinforcement member 240 providing support, the width of the base 22 may be reduced and/or a smaller biasing member 26 may be utilized such that the viewing area through the film 30 may be increased and the overall weight of the assembly 10 may be reduced.

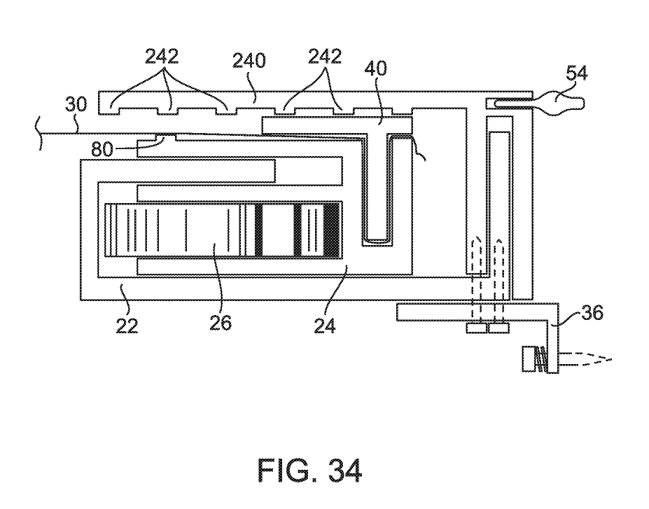

Referring now to FIG. 34, an embodiment of the assembly 10 is illustrated that includes the reinforcement member 240 coupled to the base 22 and configured to reinforce the assembly 10 upon tensioning of the film 30. Like the embodiment illustrated in FIG. 33, the reinforcement member 240 of FIG. 34 extends in a direction parallel to the film 30 illustrated in FIG. 33 over the cap 40. The reinforcement member 240 provides enhanced tension for the base 22 and/or other components of the assembly 10 along the length of the assembly 10. The reinforcement member 240 of FIG. 34 may include any or all of the features, configurations, and/or functions of the embodiment of FIG. 33. In the embodiment of FIG. 34, the reinforcement member 240 further includes one or more reinforcement member teeth 242 extending toward the slide 24 and/or the cap 40 of the assembly 10. Further, in the embodiment of FIG. 34, the base film edge 80 is disposed on, at, or as part of the slide 24. In such a configuration, the base film edge 80 moves with the slide 24, thereby allowing movement, tensioning, and/or other adjustment of the film 30 and/or the assembly 10 to occur while maintaining generally constant contact of the film 30 at the base film edge 80. As with any feature or function of any embodiment described herein, one of ordinary skill in the art will recognize that any feature or function of the embodiment of FIG. 34 may be utilized in another embodiment described herein.

In any embodiment described herein, the assembly 10 includes a lubricant and/or a low-friction surface, such as a polytetrafluoroethylene surface in a non-limiting example, applied to and/or positioned as a surface of the slide 24, the base 22, the primary biasing member 26, the cap 40, and/or any member or portion of the assembly 10. A low-friction surface includes spheres, cylinders, bearings, rollers, or any similar rolling component in order to allow efficient and accurate operation. The lubricant and/or low-friction surface reduces the likelihood that the surface(s) and/or edge(s) of the assembly 10 will bind or otherwise not perform efficiently and/or accurately.

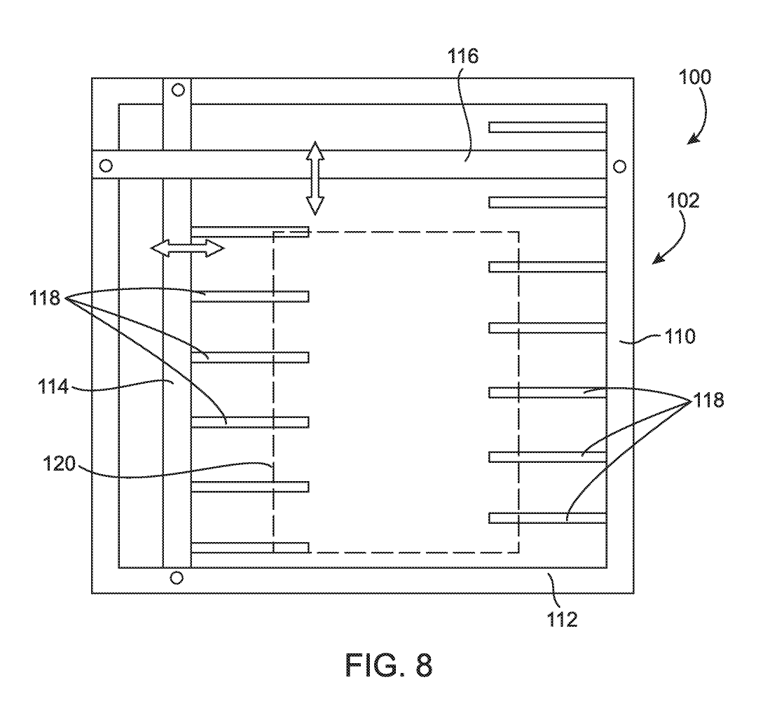

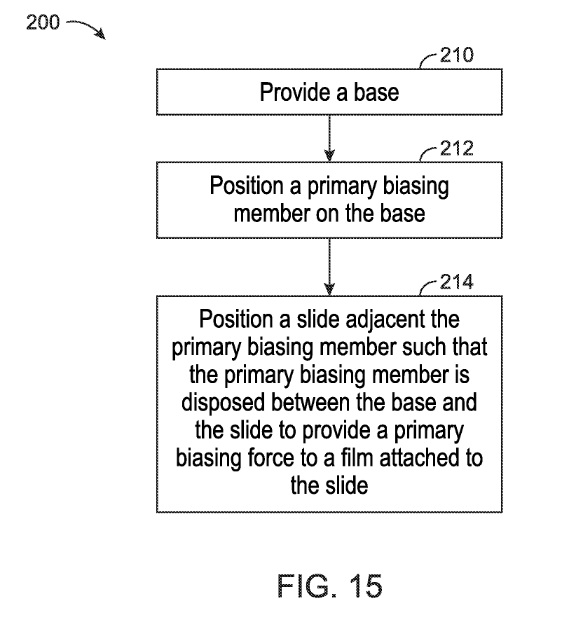

Referring now to FIGS. 8-15, embodiments of a system 100 and a method 200 of forming the assembly 10 are provided. In accordance with embodiments of the present disclosure, a method 200 of assembling or otherwise forming the assembly 10 is provided, as illustrated in FIG. 15. The method 200 of an embodiment includes providing, at step 210, the base 22, positioning, at step 212, the primary biasing member 26 on the base 22, and positioning, at step 214, the slide .24 adjacent the primary biasing member 26 such that the primary biasing member 26 is disposed between the base 22 and the slide 24 to provide the primary biasing force 32 to the film 30 attached to the slide 24.

Further embodiments include applying a loading force 204 in a first direction 206 against the primary biasing force 32, attaching the film 30 to the slide 24, and releasing the loading force 204 to apply the primary biasing force 32 to the film 30.

Attaching the film 30 includes inserting the film 30 into the film attachment channel 46 in an embodiment. Attaching the film 30 in an embodiment includes adhering the film 30 to the slide 24. In an embodiment, the adhesive 50, such as a spray glue in one non-limiting example, is applied inside the film attachment channel 46 before inserting the film 30 into the film attachment channel 46.

The method 200 of an embodiment includes trimming a film portion 208. Trimming the film portion 208 occurs after inserting into and/or attaching the film 30 to the slide 24 in an embodiment. The method 200 of an embodiment of the present disclosure includes applying a secondary biasing force 202 to the film 30. In an embodiment, applying the secondary biasing force 202 includes positioning the cap 40 on the slide 24 whereby the cap 40 and/or the slide 24 includes one or more protrusions 42 to increase tension of the film 30.

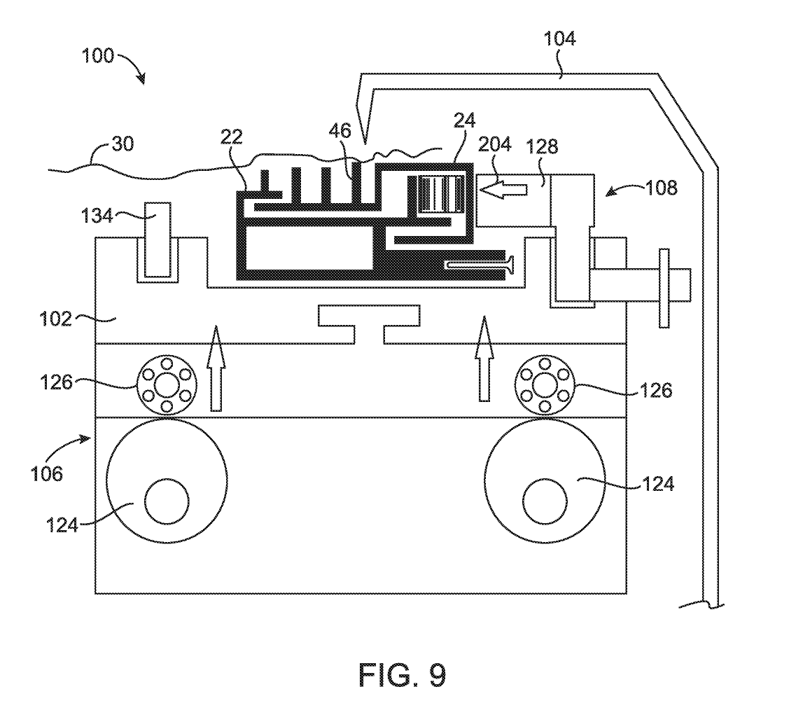

As illustrated in FIG. 8, a system 100 for assembling or forming the assembly 10 includes a fixture 102 configured to support the base. 22 and the slide 24, as further illustrated in FIG. 9. The fixture 102 of the system 100 illustrated in FIG. 8 includes a first stationary portion 110, a second stationary portion 112, a first moveable portion 114 extending substantially parallel to the first stationary portion 110, and a second moveable portion 116 extending substantially parallel to the second stationary portion 112. In an embodiment of the present disclosure, the portions 110, 112, 114, 116 are relatively adjustable in order to support the base 22, the slide 24, and/or the cap 40 of a predetermined size. The predetermined size is substantially equal to the size of the opening 12 in one non-limiting example. In such a non-limiting example, the dimensions of the opening 12 are determined before the base 22 is formed such that the outer dimensions of the base 22 are less than or substantially equal to the dimensions of the opening 12. The base 22 includes extruded or otherwise formed sides having one or more of the structures described herein that are miter cut and joined or otherwise rigidly fixed together at each junction 70 of each of the sides 14, 16, 18, 20. In additional embodiments of the present disclosure, the base 22 and the slide 24 of each side are initially joined, or the sides 14, 16, 18, 20 are otherwise at least partially assembled, before the assemblies of each side 14, 16, 18, 20 are joined at the corners of the assembly 10, such as by welding, adhesion, or fastening in non-limiting examples.

The base 22, the slide 24, and/or the cap 40 are made from a metal in an embodiment, such as aluminum in one non-limiting example, from a polymeric material in an embodiment, such as polyvinyl chloride in one non-limiting example, from a natural material, such as wood in one non-limiting example, and/or from another material known by those having ordinary skill in the art. In an embodiment, the base 22, the slide 24, and/or the cap 40 are extruded to form one or more of the structures described herein,

The method 200 according to another embodiment includes positioning the base 22 on the fixture 102, positioning the primary biasing member 26 on the base 22, positioning the slide 24 on the base 22 such that the primary biasing member 26 is between the base 22 and the slide 24, positioning the film 30 between the inserter 104 and the slide 24, and moving the fixture 102 and/or the inserter 104 toward each other to attach the film 30 to the slide 24.

The method 200 of an embodiment includes applying or actuating the loading force 204 before positioning the film 30 between the inserter 104 and the slide 24. The method 200 further includes removing or releasing the loading force 204 following attachment of the film 30 to the slide 24. In an embodiment not shown, the method 200 includes removing or releasing the loading force 204 after the cap 40 is positioned on and/or attached to the slide 24. Actuating the loading force 204 in an embodiment includes actuating one or more loader cams 128. Moving the fixture 102 and/or the inserter 104 includes moving the fixture 102 with the one or more loader cams 128 in an embodiment.

In an embodiment of the present disclosure not illustrated, the fixture 102 and/or the method 200 do not include the one or more loader cams 128 or applying or actuating the loading force 204 before positioning the film 30 between the inserter 104 and the slide 24. In such embodiments, such as the embodiment of the assembly 10 illustrated in FIG. 16, the film 30 is positioned above the base 22 before the slide 24 is positioned over or onto the base 22. By virtue of the film attachment protrusion 48 pushing the film 30 into the film attachment channel 46, the film 30 becomes locked, fixed, or otherwise attached to the slide 24 and the base 22. Further, the film 30 travels into the film attachment channel 46 to move the slide 24 in a direction toward the film 30 against the primary biasing force 32. As such, in an embodiment, the assembly 10 becomes loaded by the primary biasing member 26 upon attachment of the film 30 and the slide 24. The film 30 travels into the film attachment channel 46 .a distance equal to the travel of the slide 24 in an embodiment.

In any embodiment of the present disclosure, the assembly 10 and/or the film 30 becomes loaded or placed under tension in an environment having a predetermined temperature. The predetermined temperature is between 50 and 100 degree in an embodiment, between 60 and 80 degrees in another embodiment, and between 65 and 75 degrees in another embodiment.

Further, in an embodiment, the one or more protrusions 42 may then apply the secondary biasing force 202 to the film 30 as described above. In an embodiment, the assembly 10 does not include the protrusions 42 such that the secondary biasing force 202 is not applied to the film 30. In any embodiment described herein, the method 200 may not include trimming the film portion 208. After inserting and/or attaching the film 30 into the slide 24 in an embodiment, the film portion 208 may be allowed to remain extended between the slide 24 and the base.

As illustrated in FIG. 8, once the portions 110 112, 114, 116 of the fixture 102 are adjusted or moved to correspond with the size of the base 22 or other assembly 10 part, the base 22 is positioned on the portions 110, 112, 114, 116 of the fixture 102. As illustrated in FIG. 8, the first stationary portion 110 and/or the first moveable portion 114 include one or more film support members 118 extending therebetween to support the film 30. The one or more film support members 118 support the film 30 as the film 30 is extended over, between, and/or across the base 22, the slide 24, and/or other part of the assembly 10. In an embodiment, the one or more film support members 118 include a plurality of rods extending from the first stationary portion 110 and the first moveable portion 114 and being positioned in a staggered formation to allow the first stationary portion 110 and the first moveable portion 114 to move together without interference between the film support members 118. In an embodiment, a film support panel 120 is positioned upon, through, or otherwise adjacent to the film support member(s) 118 to further support the film 30. In an embodiment, the film support panel 120 is a rectangular, polystyrene foam board resting upon the film support member(s) 118 to evenly support the film 30 while being easily moved and adjusted relative to the fixture 102.

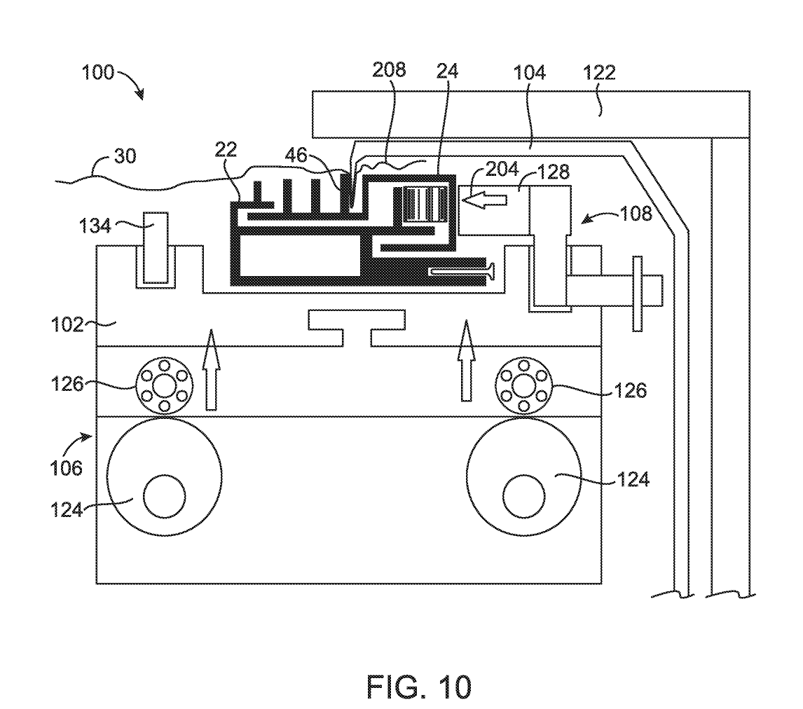

As illustrated in FIG. 9, the system 100 further includes an inserter 104 configured to insert, push, poke, or otherwise move the film 30 into the film attachment channel 46 of the slide 24 such that the film 30 is attached to the slide 24. FIG. 10 illustrates the inserter 104 being, moveable relative to the fixture 102 in order to insert the film 30 into the slide 24. In additional embodiments, the inserter 104 moves the film 30 into attachment with the slide 24 in accordance with other types of movement or mechanisms. In an embodiment not illustrated, the inserter 104 is capable of sliding or rolling lengthwise or widthwise into place above the film attachment channel 46 for operation before being slid or rolled away for the next operation. Additionally, in an embodiment, the inserter 104 pivots or rotates into place for operation before being pivoted or rotated out of the way after insertion of the film 30 into the film attachment channel 46.

The embodiment of FIGS. 9 and 10 further illustrates a fixture compressor 106 configured to move the inserter 104 toward the fixture 102 and/or the fixture 102 toward the inserter 104. In an embodiment, the fixture 102 is moved upward toward the stationary inserter 104 as illustrated in FIGS. 9 and 10. In an embodiment, the system 100 includes an inserter stop 122 positioned above, against, or adjacent to the inserter 104 to prevent upward or otherwise unintended or undesirable movement of the insert 104. The inserter stop 122 in an embodiment is integral with the inserter 104. In an embodiment, the inserter 104 is rotationally, pivotally, or otherwise moveably coupled to the inserter stop 122.

The fixture compressor 106 of the illustrated embodiments includes one or more insertion cams 124 operably coupled to one or more bearing members 126 coupled to or forming part of the fixture 102. Rotation or operation of the cam(s) 124 results in upward movement of the bearing member(s) 126 and fixture 102 such that the inserter 104 inserts, pushes, pokes, or otherwise moves the film 30 into the film attachment channel 46 of the slide 24 to attach the film 30 to the slide 24.

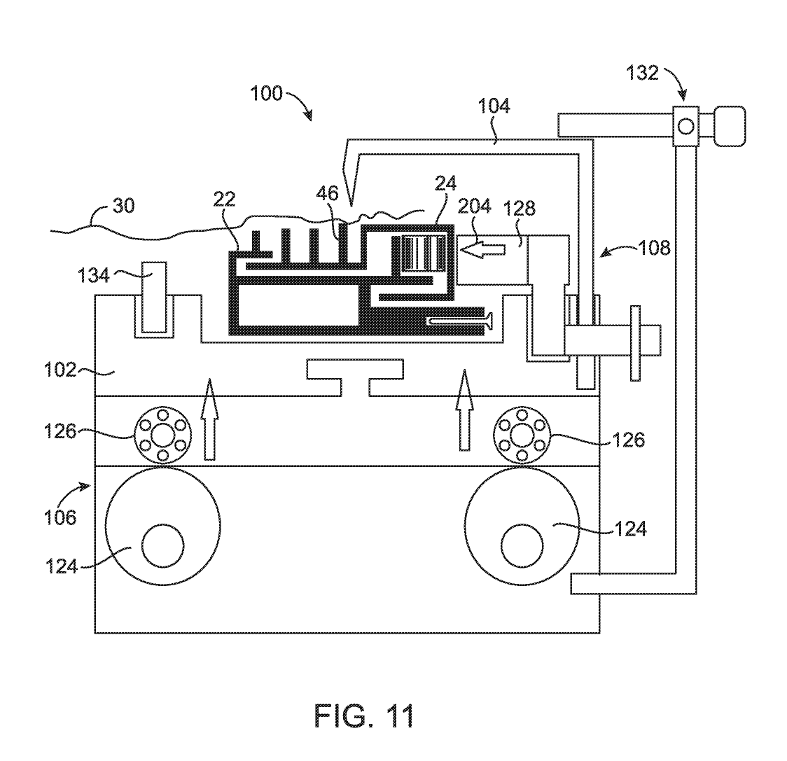

In an embodiment illustrated in FIG. 11, the system 100 includes an inserter driver 132 configured to move the inserter 104 toward the slide 24 to allow the film 30 to be inserted into the film attachment channel 46. In an embodiment, the inserter driver 132 replaces the fixture compressor 106 and, in another embodiment, the inserter driver 132 supplements the fixture compressor 106 to insert the film 30 into the film attachment channel 46. The inserter driver 132 of particular embodiments includes, without limitation, a mechanical lever driver, as illustrated in FIG. 11, a hydraulically or pneumatically powered driver, and/or another driver that one of ordinary skill in the art, having reviewed and understood the present disclosure, would recognize as being capable of moving the inserter 104 toward the slide 24.

As further illustrated in the embodiment of FIG. 10, the system 100 further includes a fixture force loader 108 configured to compress the primary biasing member 26 positioned between the base 22 and the slide 24 and/or otherwise move the slide 24 inward relative to the base 22 and/or the fixture 102. FIGS. 9-11 illustrate the primary biasing member 26 being loaded or compressed by the loader cam(s) 128. In an embodiment, the fixture force loader 108 simultaneously compresses the primary biasing member 26 on all of the sides 14, 16, 18, 20 of the base 22.

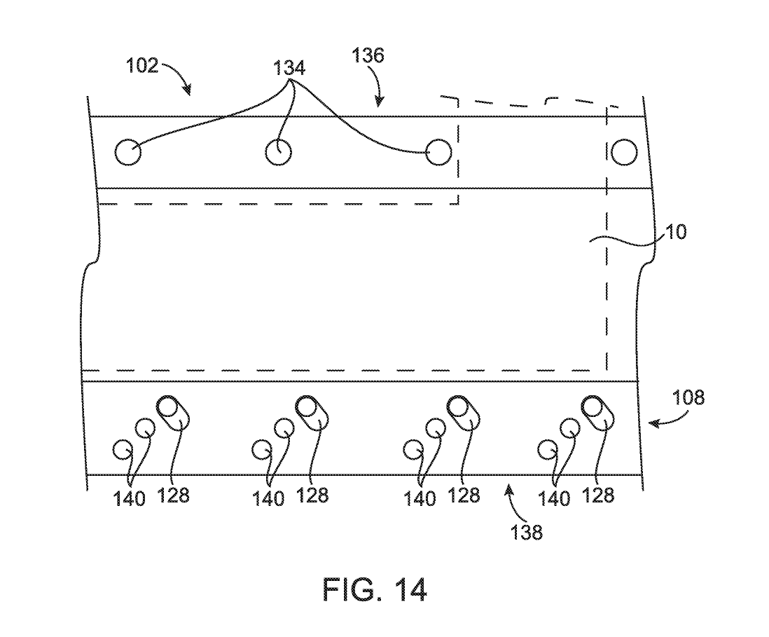

FIG. 14 illustrates the fixture force loader 108 as a plurality of loader cams 128 that simultaneously applies force to the slide 24 and primary biasing member 26 in accordance with an embodiment. One or more fixture positioning members 134 are included at a first side 136, such as an inner side, of the fixture 102. The fixture positioning members 134 are spaced to allow the assembly 10 to be positioned therebetween or otherwise allow the assembly 10 to be positioned through the fixture positioning members 134 in the embodiment shown. The one or more loader cams 128 are positioned on a second side 138, such as an outer side, of the fixture 102 in the embodiment illustrated in FIG. 14. As also shown in FIG. 14, one or more alternative loader cam holes, slots, or positioning structures 140 may be provided to allow expansion of the space between the fixture positioning members 134 and the loader cams 128. Although not shown, the fixture positioning members 134 may also include alternative holes, slots, or positioning members to alternatively or further allow expansion of the space between the fixture positioning members 134 and the loader. cams 128.

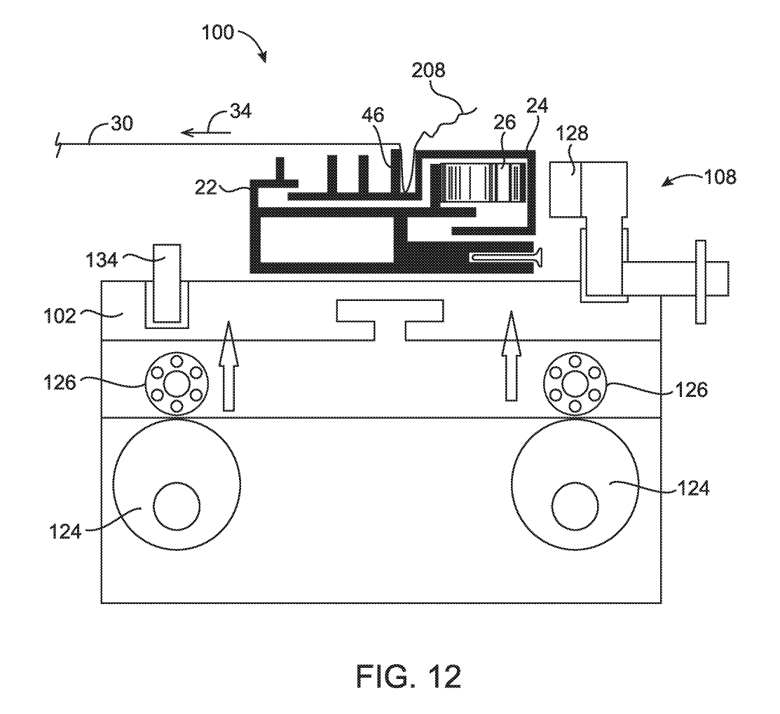

Following the compression of primary biasing member 26 and insertion of the film 30 and/or attachment of the film 30 into the slide 24, the fixture force loader 1.08 operates to release or decompress the primary biasing member 26, as illustrated in FIG. 12. At that point, the primary biasing member 26 is at least partially compressed due to, or at least partially loaded against, the film tensile force 34.

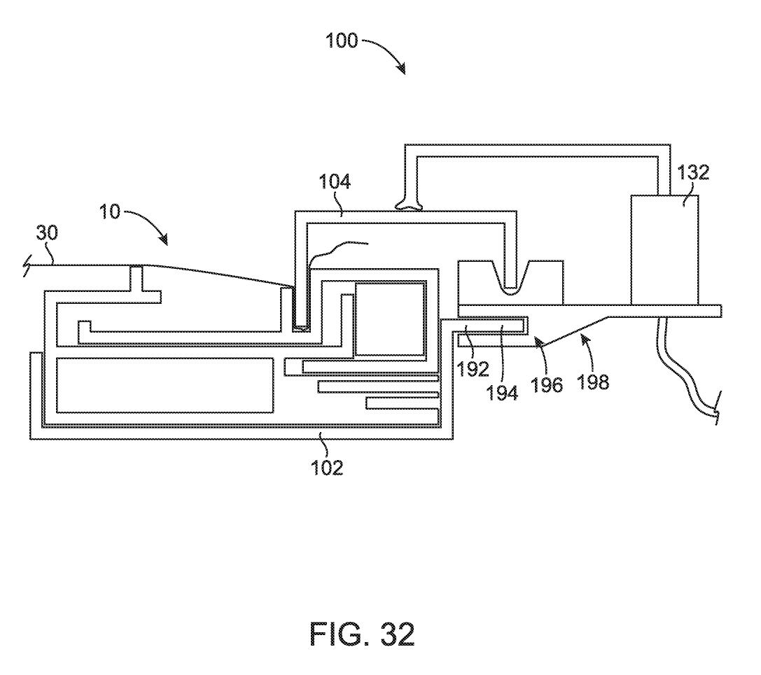

Referring now to FIG. 32, an embodiment of the. system 100 includes a detachable assembly 198. The detachable assembly 198 of the embodiment illustrated in FIG. 32 includes the inserter driver 132 being detachable and attachable to the fixture 102 or another tray or structure having an attachment portion 192. In the embodiment of FIG. 32, the attachment point 192 of the fixture 102 is a lip 194 disposed on an outer end 196 of the fixture 102. The system, 100 of FIG. 32 includes the inserter 104 separated, pivotable, or otherwise moveable relative to one or more other portions of the inserter driver 132. In one or more embodiments, the fixture force loader 108 or another component or portion of the system 100 forms at least part of the detachable assembly 198. The detachable assembly 198 of the embodiment of FIG. 32 allows the inserter driver 132 or other component to be quickly and easily attached and detached from the fixture 102, tray, or other assembly support component. The detachable assembly 198 may then be moved to another portion of the assembly 10 to operate the inserter 104, the inserter driver 132, the fixture force loader 108, and/or another member of the system 100.

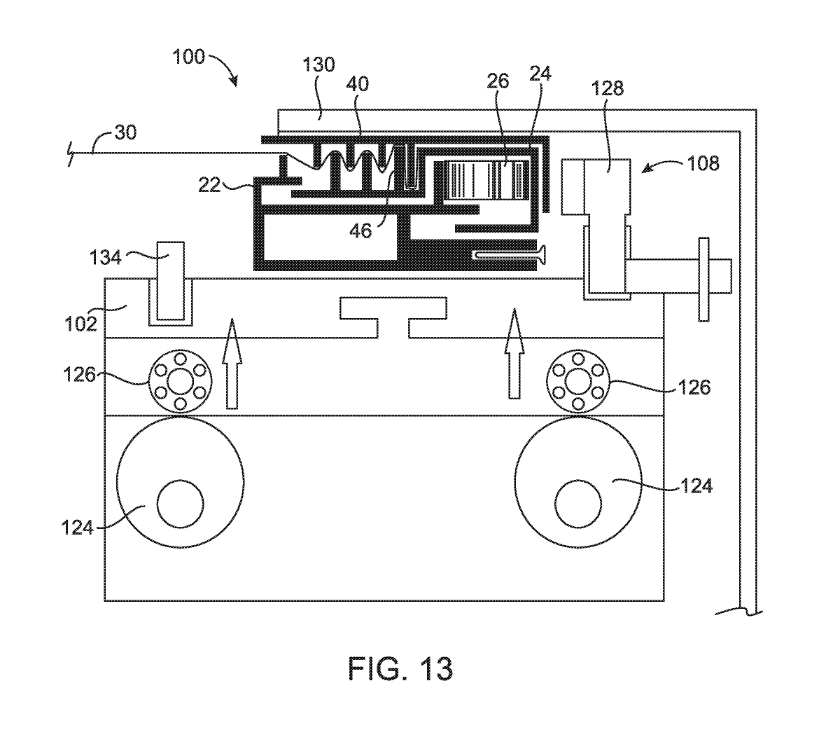

Referring now to FIG. 13, the system 100 includes a cap stop 130 configured to resist upward or otherwise unintended or undesirable movement of the cap 40 following positioning of the cap 40 on the slide 24 upon movement of the fixture 102 toward the cap stop 130.

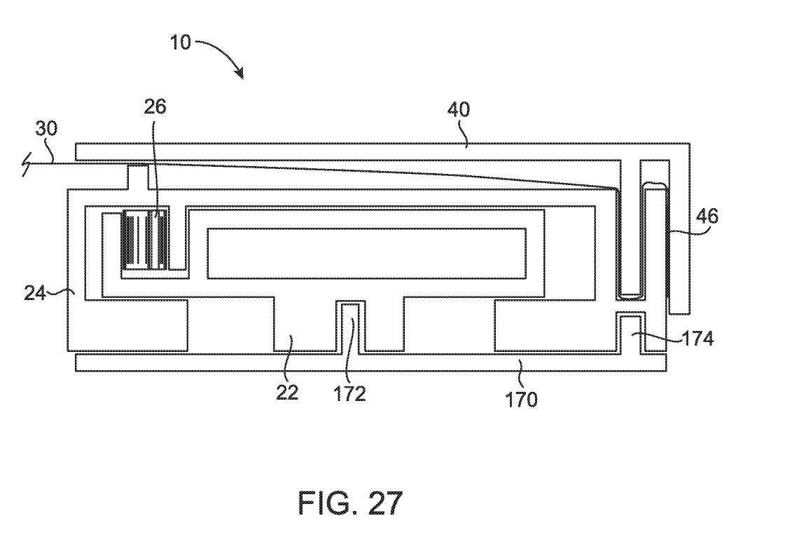

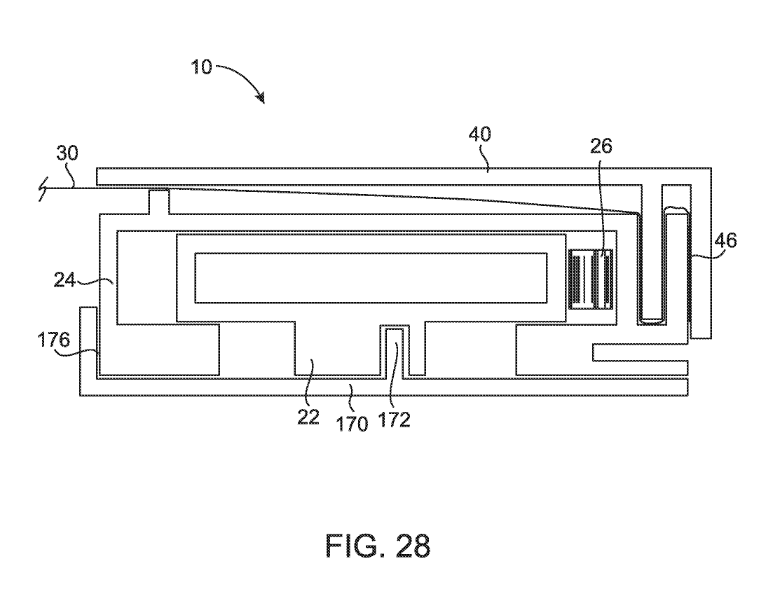

Referring now to FIGS. 27 and 28, embodiments of the system 100 for assembling or forming the assembly 10 includes a fixture bracket 170 configured to fix and/or hold each of the base 22 and the slide 24 in a predetermined loaded position relative to each other. The embodiments illustrated in FIGS. 27 and 28 includes the structures illustrated in FIGS. 25 and 26. However, the base 22, slide 24, and/or cap 40 of any assembly 10 disclosed herein may incorporate the fixture bracket 170 and/or any other feature illustrated in FIGS. 27 and 28.

FIG. 27 illustrates an embodiment of the fixture bracket 170 fixing and/or holding the base 22 at a first fixation point 172 and the slide 24 at a second fixation point 174. In an embodiment, the fixture bracket 170 fixes and/or holds the base 22 and the slide 24 in the predetermined loaded position illustrated in FIG. 27 after the primary biasing member 26 is at least partially loaded. As with other embodiments described herein, the cap 40 is positioned above the slide 24 to secure the film 30 into the film attachment channel 46. In additional embodiments, the film 30 is secured into the film attachment channel 46 in accordance with any other method or structure described in the present disclosure. After the film 30 is secured into the film attachment channel 46, the film 30 is under tension and substantially fixes or holds the slide 24 and the base member 22 in the predetermined loaded position against the primary biasing force 32 of the primary biasing member 26. The fixture bracket 170 may be removed from the base 22 and the slide 24 at that point. In other embodiments, the fixture bracket 170 remains attached to at least the base 22 to form the bracket 36 or another structure of the assembly 10.

FIG. 28 illustrates an embodiment of the fixture bracket 170 fixing and/or holding the base 22 at the first fixation point 172 and the slide 24 at a third second fixation point 176 located at an end of the slide 24. As with the embodiment of FIG. 27, the fixture bracket 170 fixes and/or holds the base 22 and the slide 24 in the predetermined loaded position illustrated in FIG. 28 after the primary biasing member 26 is at least partially loaded. As illustrated in FIGS. 27 and 28, the primary biasing member 26 may be positioned on either end of the base 22. As with other embodiments described herein, the cap 40 is positioned above the slide 24 to secure the film 30 into the film attachment channel 46. In additional embodiments, the film 30 is secured into the film attachment channel 46 in accordance with any other method or structure described in the present disclosure. After the film 30 is secured into the film attachment channel 46, the film 30 is under tension and substantially fixes or holds the slide 24 and the base member 22 in the predetermined loaded position against the primary biasing force 32 of the primary biasing member 26. The fixture bracket 170 may be removed from the base 22 and the slide 24 at that point. In other embodiments, the fixture bracket 170 remains attached to at least the base 22 to form the bracket 36 or another structure of the assembly 10.

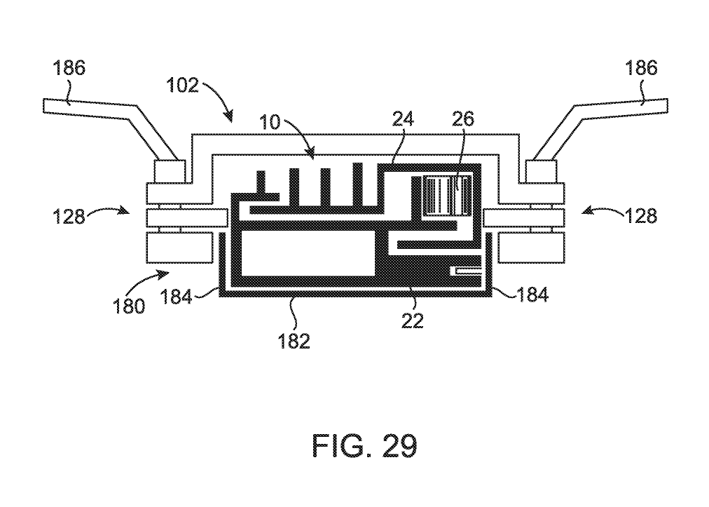

Referring now to FIG. 29, an embodiment of the system 100 is illustrated. The embodiment of FIG. 29 illustrates an embodiment of the fixture 102 having one or more loader cams 128 or any other loading structures or methods described herein, including loader cams 128 disposed on each side of the assembly 10, configured to at least partially load the assembly by at least partially loading or compressing the primary biasing member 26. The loader cams 128 illustrated in FIG. 29 include handles 186 that a user would rotate, move, or otherwise operate to apply a load using the loader cams 128. The fixture 102 of FIG. 29 includes a lower portion 180 that is at least partially open and a tray 182 sized and/or configured to be positioned below and/or in the lower portion 180. Following at least partial loading of the primary biasing member 26, the slide 24 and the base 22 are configured and/or sized to fit into the tray 182. The tray 182 is positioned such that the slide 24 and the base 22 are positioned at least partially within the tray 182 before the one or more loader cams 128 or other loading structures or methods reduce or remove its/their loading force. Outer ends 184 of the tray 182 retain, fix, and/or hold the slide 24 and the base 22 at their at least partially loaded positions.

Although not illustrated, the tray 182, the slide 24, and the base 22 may then be moved away from the remaining portions of the fixture 102 to allow further assembly, such as the film 30 being attached to the slide 24, the cap 40 being attached to the slide 24, and/or any other operation described in the present disclosure. Upon attachment of the film 30 via one or more structures or methods described in the present disclosure, the tray 182 may be removed. The slide 24, the base 22, and any other component of one or more embodiments described in the present disclosure may be utilized in the embodiment of FIG. 29.

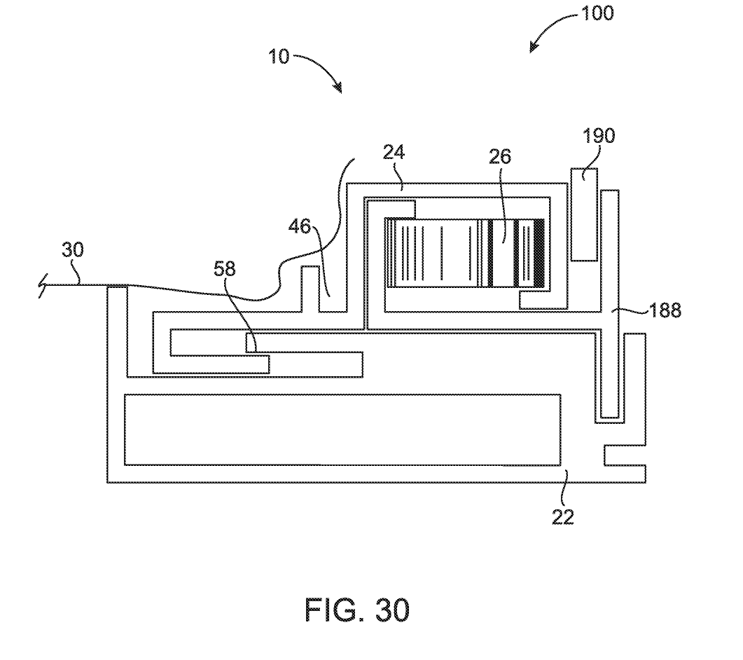

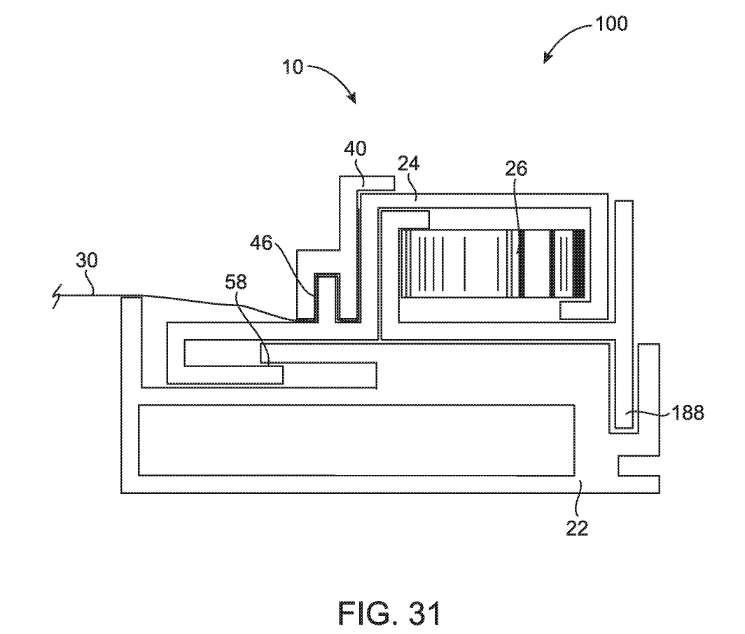

Referring now to FIGS. 30 and 31, an embodiment of the assembly 10 and the system 100 is illustrated. The embodiment of FIG. 30 illustrates the primary biasing member 26 being located above or outside of the base 22 and between the slide 24 and a stationary base insert 188. The base insert 188 is configured to be inserted into and/or fixed with the base 22 in the embodiment illustrated in FIG. 30. In additional embodiments not shown, the base insert 188 is integrally formed with the base 22 or fixed to the base 22 in any manner described herein. The base 22 includes one or more slide channels 58 extending in a direction substantially parallel to the film 30 in the embodiment illustrated in FIGS. 30 and 31.

In the embodiment of FIG. 30, the slide 24 and/or the primary biasing member 26 is at least partially loaded using any structure or method described herein, such as by moving the slide 24 to the left in the embodiment illustrated using one or more loader cams 128 not illustrated in FIG. 30. A slide holder 190 is then positioned outside of the slide 24 and inside of the base insert 188, as illustrated in FIG. 30, in order to lock or hold the slide 24 or otherwise prevent movement of the slide 24 back toward the right upon reduction or release of the at least partial loading. While the slide holder 190 holds the at least partially loaded position of the slide 24, the film 30 is attached to the slide 24, such as at the film attachment channel 46 in a non-limiting example.

Referring now to FIG. 31, following attachment or fixation of the film 30 to the slide 24, the slide holder 190 is removed to create tension of the film 30. The cap 40 is then positioned as illustrated in FIG. 31 to lock, fix, or otherwise secure the film 30 to the slide 24. In an embodiment, while the slide holder 190 is positioned between the slide 24 and the base insert 188, the cap 40 is positioned into the film attachment channel 46 to lock, fix, or otherwise secure the film 30 to the slide 24. The slide holder 190 is then removed to allow the primary biasing member 26 to provide tension to the film 30. As with all previous embodiments described herein, any feature(s), structure(s), and/or method(s) of one or more embodiments described in the present disclosure may be utilized in the embodiment of FIGS. 30 and 31.

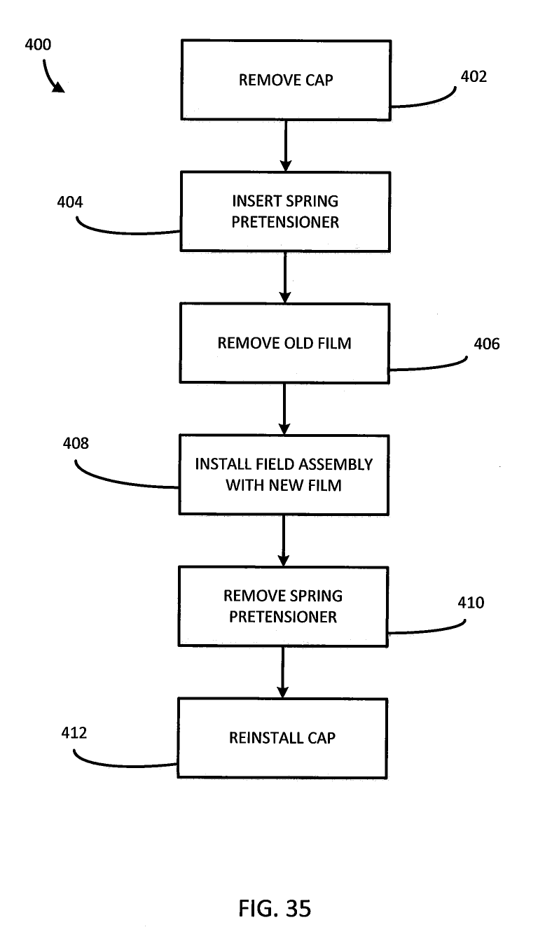

Referring now to FIG. 35, a method 400 of replacing film in a fenestration assembly according to at least one embodiment of the present disclosure is provided, as may be necessary if the film (such as film 30) becomes damaged. The method 400 of an embodiment includes, at step 402, removing the cap (such as cap 40). At step 404, if necessary a spring pretensioner is installed or inserted or deployed in such a manner as to reduce the tension on the film (such as film 30). As step 406, the old film is removed, and at step 408, new film is installed. In at least one embodiment of the present disclosure, the new film installed at step 408 is mechanically affixed to a field assembly unit that will remain in assembly 10 following replacement of the film. At step 410, if a spring pretensioner was used at step 404, the spring pretensioner is remove such that tension on the film (such as film 30) is restored. At step 412, the cap (such as cap 40) is reinstalled.

The embodiments described and illustrated in the present disclosure reference and relate to the use of the film 30 as a material to be tensioned or otherwise utilized for the embodiments. In the embodiments described and illustrated in the present disclosure, film 30 may be tensioned or tightened to a desired tautness including, by way of non-limiting example, by selection of a biasing member 26 having properties to produce such a desired tautness. In addition, one having ordinary skill in the art, after reviewing and understanding the present disclosure, will recognize that any flexible, flimsy, and/or elastic material, or any material capable of being tensioned or tightened to a desired tautness, may be utilized in place of or in addition to the film 30. However, one having ordinary skill in the art, after reviewing and understanding the present disclosure, will recognize that any flexible, flimsy, and/or elastic material, or any material capable of being tensioned or tightened to a desired tautness, may be utilized in place of or in addition to the film 30. One or more non-limiting examples of such materials include cloth, polymer(s), elastomer(s), and a mesh or chain formed by a metal, polymer, or other material. Additionally, the components of the assembly 10, including but not limited to the base 22, the slide 24, the cap 40, and/or the reinforcement member 240, may be made from a polymer, a metal, a composite, a wood or other natural material, or any other material capable of providing a desired amount of rigidity. Further, components of the assembly 10 may be made from different materials. To illustrate, in one non-limiting example, the base 22 may be made from a metal while the slide 24 may be made from a polymer. In one or more embodiments, if two components are assembled together or otherwise in contact, such as the slide 24 and the cap 40 in two non-limiting examples, and are made from different materials, the coefficient of thermal expansion of the materials is comparable in order to maintain desired fitment and tolerances within the assembly 10 over a wide and varying temperature range.

While the disclosure has been illustrated and described in detail in the drawings and foregoing description, the same is to be considered as illustrative and not restrictive in character, it being understood that only certain embodiments have been shown and described and that all changes and modifications that come within the spirit of the disclosure are desired to be protected.

What is claimed is:

1. A fenestration assembly comprising:
a base configured to be coupled to a window portion;
a slide coupled to the base and having a film attachment point, the slide being biased to increase tension of a film attached at the film attachment point; and
a reinforcement member coupled to the base and configured to reinforce the assembly upon tensioning of the film.

2. The assembly of claim 1, further comprising a biasing member disposed between the base and the slide and configured to bias the slide to increase tension of the film attached at the film attachment point.

3. The assembly of claim 2, wherein the biasing member is substantially aligned with the film along a direction of tension of the film.

4. The assembly of claim 2, wherein the biasing member is a wave spring.

5. The assembly of claim 1, wherein the base includes a channel extending in a direction substantially parallel to the film and the slide includes a tab extending in the direction substantially parallel to the film and being disposed in the channel.

6. The assembly of claim 1, further comprising a cap coupled to the slide and configured to cover at least a portion of the slide.

7. The assembly of claim 6, wherein the cap includes at least one protrusion extending in a direction substantially perpendicular to the film, the at least one protrusion configured to further increase tension of the film.

8. The assembly of claim 1, wherein the window portion is a window frame.

9. The assembly of claim 1, wherein the window portion is a window pane.

10. The assembly of claim 1, wherein the base is configured to be coupled to the window portion with a bracket coupled to the base, the bracket providing tension to the base in a direction that is substantially parallel to a direction of tension on the film.

11. A fenestration assembly comprising:
a stationary member;
a moveable member coupled to the stationary member;
a primary biasing member disposed between the stationary member and the moveable member to provide tension to a film coupled to the moveable member; and
a reinforcement member coupled to the stationary member and configured to reinforce the assembly upon tension being provided to the film.

12. The assembly of claim 11, wherein the primary biasing member is substantially aligned with a direction of tension of the film.

13. The assembly of claim 11, further comprising a secondary biasing member disposed at the moveable member to further provide tension to the film.

14. The assembly of claim 13, wherein the moveable member includes an inner moveable member and an outer moveable member, the secondary biasing member being formed between the inner moveable member and the outer moveable member.

15. The assembly of claim 14, wherein the secondary biasing member is formed by at least one of the inner moveable member and the outer moveable member having at least one protrusion extending substantially perpendicular to a direction of tension on the film.

16. The assembly of claim 11, wherein the primary biasing member is a wave spring.

17. The assembly of claim 11, wherein the stationary member includes a channel extending substantially parallel to a direction of tension on the film and the moveable member includes a tab extending substantially parallel to the direction of tension on the film and being disposed within the channel.

18. The assembly of claim 11, further comprising a bracket coupled to the stationary member, the bracket configured to be coupled to a window portion and providing tension to the base in a direction that is substantially parallel to a direction of tension on the film.
